(19) United States
(12) Patent Application Publication
(10) Pub. No.: US 2026/0278935 A1
(43) Pub. Date: Sep. 17, 2026

(54) SYSTEM

(71) Applicant: SoftBank Group Corp., Tokyo (JP)

(72) Inventor: Yusuke KATAFUCHI, Tokyo (JP)

(73) Assignee: SoftBank Group Corp., Tokyo (JP)

(21) Appl. No.: 19/550,285

(22) Filed: Feb. 26, 2026

Related U.S. Application Data
(60) Provisional application No. 63/771,314, filed on Mar. 13, 2025.

(51) Int. Cl. G06T 17/20; G06N 3/0464; G06N 3/0475; G06T 15/04; G06V 10/46; G06V 10/77

(52) U.S. Cl. CPC G06T 17/20; G06N 3/0464; G06N 3/0475; G06T 15/04; G06V 10/46; G06V 10/7715

(57) ABSTRACT

A system includes a processor that is configured to receive past image data and geographic information via an input unit, analyze the received data via an analysis unit to extract features from the received data, generate a three-dimensional virtual reality space via a generation unit based on the extracted features, and optimize the generated three-dimensional virtual reality space via an optimization unit and output the optimized three-dimensional virtual reality space in a form in which a user can experience the three-dimensional virtual reality space.

### CROSS-REFERENCE TO RELATED APPLICATION

This application claims the benefit of U.S. Provisional Application No. 63/771,314, filed on Mar. 13, 2025, pursuant to 35 U.S.C. § 119(e), the entire contents of which are incorporated herein by reference.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional techniques for providing virtual representations of cities and landscapes suffer from several limitations. First, many existing systems rely on manually created three-dimensional models or static datasets, which require substantial time, expertise, and cost to produce and update, and therefore cannot flexibly reflect diverse historical periods or user-specific scenarios. Second, although various image archives, historical maps, aerial photographs, and geographic information systems exist, there is no integrated mechanism that automatically analyzes such heterogeneous data to reconstruct a consistent, three-dimensional virtual reality space that accurately reflects past urban layouts, architectural features, and terrain. Third, existing virtual reality content generation workflows typically separate content creation from optimization for end-user devices, leading to performance bottlenecks, poor rendering quality, or limited interactivity on consumer-grade terminals such as smartphones, tablets, and virtual reality headsets. Fourth, current systems provide limited support for the creation of imaginary cities or creative environments based on user-provided concept art, sketches, and textual descriptions, and therefore cannot effectively serve use cases such as game development, pseudo-travel experiences, or educational simulations that require both realism and creativity. Accordingly, there is a need for a system and method capable of: (i) automatically receiving and analyzing past image data and geographic information; (ii) generating realistic three-dimensional virtual reality spaces that reflect historical or imaginary cities; (iii) optimizing these spaces so that users can comfortably experience them on various devices in an interactive manner; and (iv) enabling deployment of the generated spaces across multiple business applications.

### SUMMARY

In order to solve the above problems, the present invention provides a system comprising a processor configured to cooperate with functional units including an input unit, an analysis unit, a generation unit, and an optimization unit. The processor is configured to cause the input unit to receive past image data and geographic information, including, for example, historical photographs, maps, aerial photographs, and geographic coordinate data, from a user or external databases. The processor is further configured to cause the analysis unit to analyze the received data using image analysis algorithms and geographic information systems so as to extract, in detail, features such as building shapes, colors, textures, urban layouts, and terrain undulations, and to classify architectural styles or city structures based on those features. The processor is additionally configured to cause the generation unit to generate a three-dimensional virtual reality space by using three-dimensional modeling technology on the basis of the extracted features, thereby reproducing a realistic urban environment that reflects past cityscapes, or, when an imaginary city is to be reproduced, to add creative elements derived from concept art, sketches, and text descriptions provided by the user so as to create unique architectural styles and landscapes. The processor is also configured to cause the optimization unit to optimize the generated three-dimensional virtual reality space by reducing polygon counts of three-dimensional models, compressing textures, constructing navigation meshes, and adding user interface and navigation functions, thereby enabling the user to freely move within and interact with the virtual reality space on terminals having limited computational resources. Furthermore, the processor is configured to utilize real-time rendering technology so that the user can comfortably experience the optimized three-dimensional virtual reality space using a virtual reality headset or other devices, and to configure the generated and optimized virtual reality space so that it can be deployed in various business scenes, including incorporation into game platforms, provision of pseudo-travel experiences, and provision as educational content.

The term “processor” refers to one or more hardware processing units, such as a central processing unit (CPU), graphics processing unit (GPU), or dedicated circuitry, and may additionally or alternatively include a combination of hardware and software that executes instructions to control the functions of the input unit, analysis unit, generation unit, and optimization unit.

The term “input unit” refers to a functional component, implemented by hardware, software, or a combination thereof, that is configured to receive data from a user, a terminal device, or an external source, including past image data and geographic information such as historical photographs, maps, aerial photographs, and geographic coordinate data.

The term “analysis unit” refers to a functional component, implemented by hardware, software, or a combination thereof, that is configured to analyze data received via the input unit, using techniques such as image analysis algorithms and geographic information systems, in order to extract features including building shapes, colors, textures, urban layouts, and terrain undulations.

The term “generation unit” refers to a functional component, implemented by hardware, software, or a combination thereof, that is configured to generate a three-dimensional virtual reality space by applying three-dimensional modeling technology to features extracted by the analysis unit, and to incorporate additional creative elements based on user-provided concept art, sketches, and textual descriptions when generating an imaginary city.

The term “optimization unit” refers to a functional component, implemented by hardware, software, or a combination thereof, that is configured to optimize a generated three-dimensional virtual reality space by performing operations such as polygon count reduction, texture compression, navigation mesh construction, user interface addition, and navigation function addition, so that a user can comfortably experience and interact with the space on various devices.

The term “past image data” refers to image-based digital information representing historical or earlier states of a city or region, including, but not limited to, historical photographs, scanned paper photographs, scanned maps, and digitized visual records of urban or geographic environments.

The term “geographic information” refers to data that describes the spatial properties and locations of natural or man-made features, including, but not limited to, maps, aerial photographs, satellite imagery, geographic coordinate data, elevation data, and vector or raster geographic information system (GIS) data.

The term “image analysis algorithm” refers to a computational method or set of methods applied to digital images to detect, segment, classify, or otherwise extract information such as building outlines, colors, textures, or object categories from the images.

The term “geographic information system” refers to hardware, software, and data structures configured to capture, store, manipulate, analyze, manage, and present geographic or spatially referenced data, including functions for map overlay, coordinate transformation, and spatial analysis.

The term “feature” refers to an attribute or characteristic extracted from the past image data or geographic information, including, for example, building shape, height, roof type, window layout, color, texture, urban layout, and terrain undulation.

The term “three-dimensional virtual reality space” refers to a computer-generated three-dimensional environment that is structured as a virtual space in which a user can visually perceive depth and spatial relationships, and can move or look around, using a display device such as a virtual reality headset, smartphone, tablet, or other terminal.

The term “three-dimensional modeling technology” refers to techniques, tools, or software used to create and manipulate three-dimensional representations of objects, buildings, terrains, and other elements, including polygonal modeling, procedural modeling, surface texturing, and material assignment.

The term “realistic urban environment” refers to a three-dimensional virtual reality space that reproduces or closely approximates the appearance, layout, and structural characteristics of an actual city or urban area, including building arrangements, road networks, and terrain features, for a particular time period.

The term “imaginary city” refers to a three-dimensional virtual reality representation of a city or urban environment that does not exist or is not limited to historical reality, and that is generated by applying creative rules or elements derived from user-provided concept art, sketches, or textual descriptions.

The term “concept art” refers to illustrative images or artwork, which may be digital or analog, that express design ideas, styles, or compositions for a city, building, or environment, and that are used as references for generating creative elements in a three-dimensional virtual reality space.

The term “sketch” refers to a drawing, illustration, or rough depiction, which may be hand-drawn or digitally created, that provides structural or stylistic hints about buildings, landscapes, or city layouts, and that serves as an input for generating an imaginary city.

The term “text description” refers to a natural language statement, phrase, or set of instructions provided by a user, which specifies desired characteristics, concepts, or constraints for generating or modifying a three-dimensional virtual reality space.

The term “polygon” refers to a basic geometric unit in a three-dimensional model, typically a triangle or quadrilateral, forming part of the surface mesh that defines the shape of objects, buildings, or terrain within a three-dimensional virtual reality space.

The term “polygon count reduction” refers to a process of simplifying a three-dimensional mesh by decreasing the number of polygons while attempting to preserve the overall shape and visual appearance of the object, in order to improve rendering performance and reduce computational load.

The term “texture” refers to image data or patterns mapped onto the surfaces of three-dimensional objects to represent visual detail such as color, material, or fine surface features that would be impractical to model solely with geometry.

The term “texture compression” refers to a method of reducing the size of texture data using encoding or compression schemes so as to lower memory usage and data transfer requirements while maintaining acceptable visual quality.

The term “navigation function” refers to a software-controlled capability that allows a user to move within or change viewpoint in a three-dimensional virtual reality space, including operations such as walking, flying, teleporting, rotating the view, or zooming in and out.

The term “user interface” refers to the set of visual, auditory, and interactive elements presented to a user, such as menus, buttons, icons, indicators, and overlays, through which the user issues commands, receives feedback, and interacts with a three-dimensional virtual reality space.

The term “real-time rendering technology” refers to techniques and systems that compute and display three-dimensional graphics at interactive frame rates, allowing a user to see immediate visual responses to movements, actions, or changes in a three-dimensional virtual reality space.

The term “virtual reality headset” refers to a head-mounted display device that presents stereoscopic or otherwise immersive visual content to a user and typically includes sensors such as gyroscopes or accelerometers for head tracking, thereby enabling the user to experience a three-dimensional virtual reality space.

The term “terminal” refers to an end-user device, such as a smartphone, tablet, personal computer, game console, or virtual reality headset, that is configured to communicate with the system, receive optimized virtual reality data, render the three-dimensional virtual reality space, and accept input from a user.

The term “business scene” refers to a commercial or practical application context in which the generated three-dimensional virtual reality space may be used, including, but not limited to, game platforms, pseudo-travel services, and educational content delivery systems.

The term “pseudo-travel experience” refers to a virtual experience in which a user can explore or observe representations of actual or imaginary locations within a three-dimensional virtual reality space in a manner analogous to traveling, without physically visiting those locations.

The term “educational content” refers to information or experiences provided through a three-dimensional virtual reality space that are intended to support learning or instruction, including, for example, historical city reconstructions, architectural studies, and geography or urban planning simulations.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

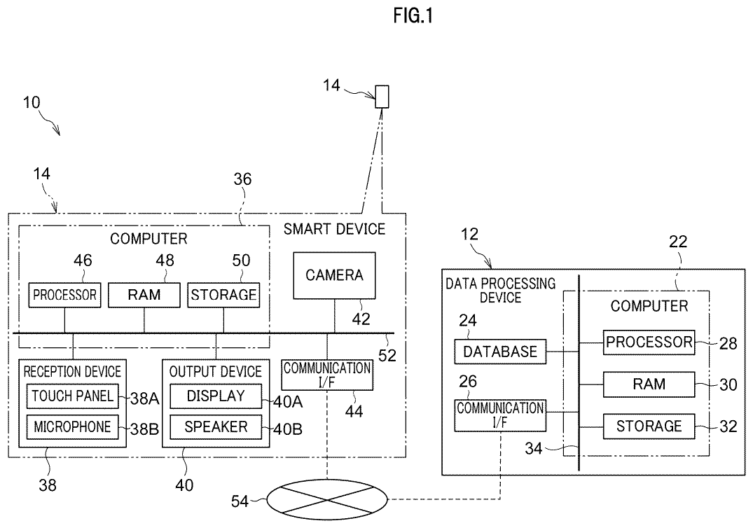

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

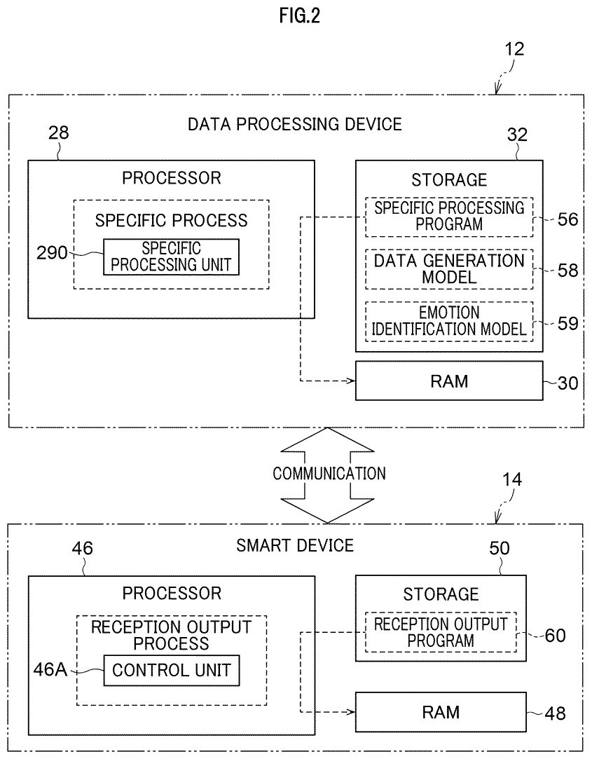

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional systems for reconstructing historical environments or generating imaginary urban environments in virtual reality generally rely on fixed content pipelines and manually authored three-dimensional assets. In such systems, processors are typically used only to load static models, apply predetermined textures, and render scenes on a display device. As a result, when a user supplies heterogeneous input data, such as historical photographs, maps, geographic coordinates, and conceptual sketches, existing systems are unable to automatically analyze these inputs at scale, synthesize coherent three-dimensional environments, or adapt content quality dynamically to the capabilities of a user terminal device. This leads to several technical problems in computer technology.

First, conventional systems exhibit limited utilization of computational resources for content generation. The processor is not configured to perform integrated image analysis, geographic information processing, and generative artificial intelligence inference as a coordinated pipeline. Instead, multiple disconnected tools and manual steps are required, which increases processing latency, underutilizes available processing units, and hinders real-time or near-real-time generation of virtual environments. This results in inefficient use of processor cycles, increased memory overhead due to redundant intermediate data, and reduced scalability when many users request customized scenes simultaneously.

Second, known systems lack a mechanism by which a processor constructs and iteratively refines machine-readable prompt sentences as generation text information for a generative artificial intelligence model based on extracted feature information and user designation information. Without such prompt construction and feedback integration at the processor level, it is difficult to drive a generative artificial intelligence model in a deterministic and controllable manner that is aligned with the results of image analysis and geographic information processing. This often produces inconsistent textures and shapes, breaks spatial coherence between analyzed input data and generated assets, and forces manual correction, thereby degrading the overall computational pipeline.

Third, conventional virtual reality rendering pipelines do not tightly couple three-dimensional environment generation with automatic optimization of polygon counts, texture compression, and multi-level detail management in response to the processing performance and runtime context of a user terminal device. In many cases, the same high-resolution assets are transmitted to all terminals, which leads to excessive network traffic, unnecessary memory consumption on low-performance devices, and unstable frame rates. The processor is not configured to segment three-dimensional space information by region and dynamically stream only necessary regions at appropriate levels of detail, resulting in suboptimal rendering performance and poor user experience on constrained hardware.

Fourth, existing systems generally handle user interaction, including viewpoint control and scene updates, through a separate application layer that is not integrated with the content generation and optimization logic at the processor. Voice-based queries and textual commands are often treated as simple UI events, rather than as structured input to an analysis unit that can reconstruct prompt sentences and trigger regeneration or modification of a virtual environment. Consequently, the computer system cannot dynamically adapt the underlying three-dimensional space information in response to user operations and audio information in an efficient, pipeline-aware manner, which limits the interactivity and responsiveness of the system.

Therefore, there is a need for an improved computer-implemented system in which a processor is specifically configured to: (i) integrate acquisition of heterogeneous electronic information, analysis of such information to extract structured feature information and high-level concept information, and construction of generation text information as prompt sentences for a generative artificial intelligence model; (ii) generate three-dimensional space information by combining extracted feature information with outputs of the generative artificial intelligence model; (iii) perform optimization processing including shape simplification, image compression, and multi-level detail generation, as well as region-based segmentation and streaming adapted to the processing performance of a user terminal device; and (iv) process user operation information and audio information as part of the same computational pipeline so that viewpoint information, movement information, and updated prompt sentences can be generated and supplied back into the analysis and generation units. By restructuring the roles of the processor in this way, the underlying computer technology for generating and distributing virtual reality environments can be improved in terms of efficiency, scalability, responsiveness, and quality of experience on heterogeneous terminal devices.

The specific processing by the specific processing unit 290 of the data processing device 12 in Example 1 is realized by the following means.

The present invention provides a server comprising a processor configured to function as an information input unit, an analysis unit, a virtual space generation unit, an optimization unit, and a user interface unit, the processor being configured to acquire heterogeneous electronic information including past image information, map information, geographic coordinate information, and user-provided conceptual information, to analyze the acquired information to extract feature information and high-level concept information, to construct generation text information as a prompt sentence based on the feature information and user designation information, to provide the generation text information as input to a generative artificial intelligence model, to obtain image information or three-dimensional shape information from the generative artificial intelligence model, to generate three-dimensional space information based on the feature information and the obtained image information or three-dimensional shape information, to perform optimization processing on the three-dimensional space information including shape simplification processing, image compression processing, generation of multi-level detail information, and region-based segmentation so as to convert the three-dimensional space information into a distribution format adapted to a processing capability of a user terminal device, and to process user operation information and audio information received from the user terminal device so as to generate viewpoint information, movement information, and additional text information to be supplied to the analysis unit. This enables the processor to implement an integrated, pipeline-oriented improvement in computer technology that automatically transforms heterogeneous input data into optimized, streamable three-dimensional virtual environments driven by generative artificial intelligence prompts, reduces redundant processing and bandwidth usage by tailoring asset complexity and streaming regions to terminal capabilities, and enhances system responsiveness by directly coupling user interaction and audio input into the analysis and generation loop, thereby improving efficiency, scalability, and quality of experience in virtual reality content generation and distribution.

The term “processor” refers to a hardware logic circuitry, such as a central processing unit, graphics processing unit, or other programmable processing device, configured to execute computer-readable instructions to perform functions of multiple logical units including acquisition, analysis, generation, optimization, and user interface processing.

The term “information input unit” refers to a logical function executed by the processor that acquires electronic information from one or more sources, including terminal devices, storage devices, and networked information providers, and prepares such information for subsequent analysis.

The term “analysis unit” refers to a logical function executed by the processor that processes acquired electronic information to extract structured data, including feature information and high-level concept information, by applying one or more analysis techniques such as image analysis, geographic information processing, and natural language processing.

The term “virtual space generation unit” refers to a logical function executed by the processor that generates three-dimensional space information including geometry, textures, and layout of a virtual environment based on feature information, configuration rule information, and output information from a generative artificial intelligence model.

The term “optimization unit” refers to a logical function executed by the processor that modifies three-dimensional space information to reduce computational load and data size, including performing shape simplification, image compression, multi-level detail management, and region-based segmentation, in order to adapt the virtual environment to capabilities of a user terminal device and network conditions.

The term “user interface unit” refers to a logical function executed by the processor that acquires, interprets, and responds to user interaction data, including operation information and audio information, and that generates control information such as viewpoint information, movement information, and sharing information for manipulating and distributing three-dimensional space information.

The term “information input unit configured to acquire information including past image information and position information” refers to a logical function executed by the processor that obtains electronic image data representing historical or prior-state scenes and electronic position data such as geographic coordinates, and that associates such data with corresponding metadata for use in subsequent processing.

The term “feature information” refers to structured data derived from analysis of input information, including but not limited to shape descriptors, appearance descriptors, arrangement descriptors, and other attributes that characterize objects, terrain, or layout within a scene.

The term “shape information” refers to data representing geometric properties of an object, such as contours, boundaries, dimensional measurements, height estimates, and three-dimensional structural attributes.

The term “appearance information” refers to data representing visual surface properties of an object, such as color distributions, textures, patterns, reflectance characteristics, and material attributes.

The term “arrangement information” refers to data representing spatial relationships and positions of objects or regions within a scene, including relative placement, orientation, adjacency, and layout of structures, roads, terrain, and other entities.

The term “user designation information” refers to input data explicitly specified by a user, including parameters such as target era, target region, desired style, scenario type, or other constraints that guide analysis and generation of three-dimensional space information.

The term “generation text information” refers to machine-readable textual data, including one or more prompt sentences, constructed by the processor based on feature information and user designation information, and intended to control or condition output of a generative artificial intelligence model.

The term “prompt sentence” refers to a natural language or structured text sequence used as input to a generative artificial intelligence model to specify desired characteristics of generated content, such as style, layout, objects, and environmental attributes.

The term “generative artificial intelligence model” refers to a trained computational model, such as a neural network or probabilistic model, configured to generate new data, including image information or three-dimensional shape information, in response to input conditions such as prompt sentences and reference data.

The term “image information” refers to digital data representing visual content, including two-dimensional raster images, textures, or rendered frames, typically encoded in one or more color channels and used for depiction of surfaces or environments.

The term “three-dimensional shape information” refers to digital data representing three-dimensional geometry of objects or environments, including meshes, point clouds, volumetric representations, or parametric models.

The term “three-dimensional space information” refers to a structured representation of a virtual three-dimensional environment, including geometry, textures, materials, lighting data, object placement, and related metadata suitable for rendering or simulation.

The term “shape simplification processing” refers to a computational process performed by the processor that reduces the complexity of geometric data, such as decreasing polygon counts or merging vertices, while maintaining perceptually similar shapes.

The term “image compression processing” refers to a computational process performed by the processor that reduces the data size of image information, such as textures or rendered images, by applying lossy or lossless compression algorithms while attempting to preserve visual quality.

The term “multi-level detail information” refers to a set of related representations of the same object or region at different resolutions or complexities, allowing a rendering system to select an appropriate level of detail based on viewing conditions or computational constraints.

The term “distribution format” refers to a data structure or packaging scheme in which three-dimensional space information and associated assets are organized for efficient transmission, streaming, and loading by a user terminal device.

The term “user terminal device” refers to an end-user computing device, such as a mobile device, tablet, personal computer, or head-mounted display, that communicates with a server, receives three-dimensional space information, and renders or displays a virtual environment.

The term “operation information” refers to data representing user interactions detected by a user terminal device, including touch inputs, pointer movements, button presses, gestures, and other control actions intended to manipulate viewpoint, position, or scene state.

The term “position information” refers to data representing spatial location of a user or device, including geographic coordinates from a positioning system and orientation data from motion sensors, used for display control and spatial alignment.

The term “audio information” refers to electronic data representing sound captured from a user, including speech signals, that can be processed for recognition, interpretation, or conversion into text.

The term “text information” refers to character-based data resulting from conversion of audio information or direct user input, used as structured input for analysis, prompt construction, or command execution.

The term “still image information” refers to digital data representing a single static image, such as a photograph, scanned document, or rendered frame, as distinct from time-varying video data.

The term “map information” refers to digital data representing geographic or spatial layouts, including road networks, land parcels, topographic features, or other cartographic elements.

The term “geographic coordinate information” refers to numerical data specifying positions on a reference surface, such as latitude, longitude, and optionally altitude, obtained from a positioning system.

The term “online information providing device” refers to a network-accessible information source, such as a server or service, that supplies electronic data including historical geographic information or other reference information via a communication network.

The term “image analysis processing” refers to computational operations performed on image information, including but not limited to filtering, segmentation, feature extraction, object detection, and classification.

The term “geographic information processing” refers to computational operations performed on map information or geographic coordinate information, including coordinate transformation, spatial analysis, feature extraction, and topology construction.

The term “building outline information” refers to data representing the boundaries or footprints of structures in a scene, typically expressed as two-dimensional polygons or polylines indicating the base shape of buildings.

The term “surface pattern information” refers to data describing repeated visual or structural patterns on object surfaces, such as brick patterns, window grids, or façade ornamentation.

The term “urban arrangement information” refers to data describing spatial organization of urban elements, including alignment and connectivity of roads, distribution of buildings, open spaces, and infrastructure layouts.

The term “terrain information” refers to data describing topographical features of the ground surface, including elevation, slope, and landform shapes.

The term “era information” refers to data indicating a temporal context, such as a historical period or future time frame, used to guide the style and content of generated environments.

The term “region information” refers to data indicating a geographic or spatial area of interest, such as a city, district, or coordinate-bounded region, used to constrain analysis and generation.

The term “configuration rule information” refers to data defining rules or constraints for arranging objects or structures in a three-dimensional space, including relationships between floating structures, connection paths, vegetation, and other environment elements.

The term “high-level concept information” refers to abstract descriptors or semantic labels derived from user-provided conceptual information, representing themes, roles, or intended characteristics of objects, structures, or environments.

The term “floating structure information” refers to data defining properties and positions of structures that are not directly supported by ground surfaces, such as airborne platforms or elevated elements.

The term “three-dimensional connection path information” refers to data defining routes or linkages that connect structures in three-dimensional space, such as bridges, walkways, or corridors at different altitudes.

The term “vegetation arrangement information” refers to data defining placement, density, and types of vegetation within a virtual environment, such as trees, shrubs, and plant-covered surfaces.

The term “virtual structure information” refers to data defining synthetic architectural or infrastructural elements generated or placed within three-dimensional space information, including geometry, materials, and positions.

The term “viewpoint information” refers to data specifying a camera or observer position and orientation in a three-dimensional space, used to determine a rendered perspective.

The term “movement information” refers to data specifying changes in viewpoint or object positions over time, including translations, rotations, and path-following behaviors.

The term “sharing operations” refers to user-initiated actions that request transmission, publication, or replication of three-dimensional space information or related scene configurations for access by other users.

The term “three-dimensional space information for another user” refers to a representation of a virtual environment derived from an original three-dimensional space information and configured or packaged for use by a different user or terminal device, optionally including modifications or access controls.

In an embodiment, a server, a terminal, and a user cooperate to implement a system for generating, optimizing, and distributing three-dimensional virtual environments based on heterogeneous electronic information, generative AI models, and structured prompt sentences.

### A. Hardware and Software Configuration

The server includes one or more processors, such as multi-core central processing units and graphics processing units, a main memory, a non-volatile storage device, and a network interface. The server runs an operating system such as a general-purpose server operating system and executes a software stack including a web application framework, an image processing library, a geographic information system (GIS) library, and a machine learning framework. For example, the server uses a web framework to expose RESTful endpoints, an image processing library such as a general image processing toolkit, a GIS library such as a spatial data processing toolkit, and a machine learning framework such as a tensor-based deep learning library. The server may also execute a three-dimensional content creation engine such as a 3D modeling tool or a game engine in a headless mode.

The terminal includes a processor, a memory, a display device, input units such as a touch screen, a microphone, and motion sensors, and optionally a camera and a positioning module such as a global navigation satellite system receiver. The terminal runs a general-purpose mobile operating system or desktop operating system and executes a client application implemented with a cross-platform game engine, a native framework, or a web runtime (for example, a WebGL or WebGPU based viewer).

The user operates the terminal through the touch screen, keyboard, pointing device, or voice input to supply input information, configure generation parameters, and navigate the resulting virtual environment.

### B. Functional Units and Data Structures

The server implements logical units by executing software modules on the processor. The logical units correspond to the information input unit, the analysis unit, the virtual space generation unit, the optimization unit, and the user interface unit as recited in the claims. Each unit is realized as one or more processes, threads, or services that exchange data through defined data structures.

The server uses data structures including:
An image dataset structure that stores historical photographs, scanned maps, or concept art images as raster arrays with metadata such as capture time, source, and spatial resolution.
A geographic dataset structure that stores vector map data (for example, road centerlines, building footprints, administrative boundaries) and raster elevation data, with attributes such as coordinate reference systems and topology.
A feature dataset structure that stores extracted feature information in tables, such as building outlines (polygon vertices), façade descriptors (histograms of oriented gradients, color histograms, texture descriptors), urban arrangement descriptors (road graphs, block polygons), and terrain descriptors (elevation grids).
A prompt dataset structure that stores generation text information, including prompt sentences, associated parameter tokens (e.g., style tags, era tags, region tags), and linkage to corresponding feature datasets.
A three-dimensional space dataset structure that stores geometry (vertex buffers, index buffers), material definitions, texture references, level-of-detail (LOD) hierarchies, and spatial partitioning information (for example, a quadtree or octree index for regional segmentation).

### C. Acquisition and Preprocessing of Heterogeneous Data

The terminal acquires past image information and position information. The terminal uses its camera to capture photographs of historical maps or buildings, converts them to digital image files, and attaches sensor metadata, such as device orientation and exposure parameters, using the operating system's imaging APIs. The terminal also acquires geographic coordinate information using the positioning module, and packages the coordinates with the image files. The user optionally downloads digital map files or historical geographic records via the terminal's network interface. The terminal stores these files locally and then transmits them to the server via a network protocol such as HTTPS, with metadata describing the file type (for example, vector map or raster map), coordinate system, and time period.

The server receives the uploaded data and normalizes it. The server converts all coordinate data into a common geographic reference frame, and the server resamples raster images to a controlled resolution range to ensure computational efficiency. The server stores the normalized data into the image dataset and geographic dataset structures.

### D. Analysis Unit and Feature Extraction

The server analyzes the normalized data using the analysis unit. The server uses a combination of classical image processing and learned models to extract features that are not readily derivable by human operators in real time.

The server applies edge detection, segmentation, and feature extraction algorithms to each input image. For example, the server computes gradients, applies a segmentation algorithm to separate sky, ground, buildings, and roads, and extracts building footprints as polygonal shapes. The server further calculates textures by computing local binary patterns or frequency-domain features. The server also computes building height estimations by combining perspective line analysis, known camera intrinsics, and reference object sizes when available.

The server implements a convolutional neural network (CNN) as part of the analysis unit for classification of architectural styles. The server constructs the CNN to have multiple convolutional layers, batch normalization layers, non-linear activation functions such as rectified linear units, and pooling layers, followed by fully connected layers that output style labels. The server trains this CNN offline using historical building image datasets annotated with style labels. During inference, the server feeds the extracted building image regions into the CNN, receives style probabilities, and stores the likely style as part of the feature dataset structure.

The server analyzes the geographic data using a GIS processing pipeline. The server uses spatial indexing trees, coordinate transformation functions, and topology-building routines. The server derives road networks as graphs, where nodes represent intersections and edges represent road segments, and the server derives urban blocks by computing polygons from cycles in the road graph. The server stores road graphs and block polygons into the feature dataset.

The server correlates the image-based building footprints with the map-based building footprints by spatial join operations and grouping by distance thresholds. This correlation yields a coherent set of buildings, roads, and terrain features within a unified coordinate system.

### E. Extraction of High-Level Concept Information for Imaginary Environments

When the user provides concept art, sketches, or textual descriptions for imaginary environments, the server processes these inputs through a multimodal analysis pipeline. The server uses an image encoder network (such as a vision transformer or CNN encoder) to map concept art images into latent feature vectors, and the server uses a text encoder network to map textual descriptions into latent vectors. The server aligns these vectors into a shared embedding space.

The server then applies clustering and embedding similarity analysis to derive high-level concept information such as “floating platforms,” “elevated gardens,” “looping skybridges,” and “dense high-rise clusters.” The server encodes these concepts as configuration rule information in a structured representation that specifies constraints, such as approximate height ranges for floating elements, preferred connectivity between buildings and floating structures, and allowed densities of vegetation placement. These configuration rules are distinct from manual modeling rules used by human designers; they are generated by algorithmic interpretation of the embedding relationships and style tokens, providing non-human, non-intuitive compositions optimized for computational generation and rendering.

### F. Construction of Generation Text Information and Prompt Sentences

The server constructs generation text information, including prompt sentences, based on the feature dataset and configuration rule information. The server uses rule-based text generation templates combined with learned phrase selection. For example, the server may generate a prompt sentence of the form:

“Reconstruct a 19th-century streetscape centered around a major landmark, with wide boulevards, stone façades, and period-appropriate street furniture, based on the provided historical maps and photographs.”

The server encodes into the prompt sentence references to specific building styles, street widths, façade materials, and time periods derived from the feature dataset.

In the case of imaginary environments, the server generates prompt sentences reflecting the high-level concept information, such as:

“Based on the supplied concept art, create a futuristic city with floating garden platforms above central plazas, transparent sky bridges connecting tall towers, and abundant vegetation integrated into building façades.”

The server constructs these prompt sentences with explicit constraints required by the downstream generative AI model, such as specifying the type of output (texture, building façade, skyline layout) and style modifiers. The server stores each prompt sentence in the prompt dataset structure along with associated features and configuration rules, enabling traceability and iterative refinement.

### G. Generative AI Model Architecture and Training

The server uses a generative AI model that may include a diffusion-based generator, a transformer-based autoregressive model, or a generative adversarial network, or a combination thereof. For example, the server can employ a conditional diffusion model trained to output high-resolution façade textures, skyboxes, or heightfield patterns given a text prompt and optionally a reference image.

The server implements the diffusion model as a U-Net backbone with attention mechanisms. The server conditions the denoising process on text embeddings obtained from a transformer-based text encoder. During training, the server feeds pairs of ground truth images and textual descriptions into the model, adds noise to the images at varying levels, and trains the U-Net to predict denoised images from noisy input and text condition. The server uses a loss function such as a mean squared error between predicted and true noise or between predicted and true clean images, and uses an optimizer such as an adaptive gradient method to update model weights.

When the server uses the generative AI model at inference time, the server converts the constructed prompt sentence into an embedding using the text encoder, initializes the diffusion process with random noise, and iteratively denoises the image while conditioning on the text embedding and, optionally, on feature maps derived from the analysis unit. The server thereby generates image information for textures or structural hints that cannot be easily authored by manual human design at scale.

The server may similarly employ a generative model that outputs three-dimensional shape information, such as a voxel-based or mesh-based generative model conditioned on text and structural constraints. The server trains this model on datasets of building meshes and associated textual labels and uses loss functions that compare generated meshes with ground truth meshes in terms of vertex positions and surface normals.

### H. Three-Dimensional Space Generation and Data Fusion

The server generates three-dimensional space information by fusing analytic features and generated assets. The server uses a 3D engine or modeling tool in a programmatic mode, with scripts or APIs that allow dynamic creation and modification of meshes, materials, and scene graphs.

The server constructs terrain geometry from elevation data by sampling a grid of elevation points and building a triangulated surface mesh. The server applies material layers for different elevation ranges or land types.

The server instantiates road meshes by extruding centerline polylines into ribbons, applying cross-sectional profiles based on road type, and generating intersections by geometric Boolean operations.

The server constructs building meshes by extruding building footprint polygons to the estimated height and applying parameterized façade subdivision rules. For example, the server divides the vertical span into floor segments and the horizontal span into window bays. The server then applies façade textures generated by the generative AI model to the mesh using UV mapping. Because the generative textures are conditioned on analyzed styles and feature descriptors, the textures align with the building's architectural style and spatial context more precisely than generic template-based textures.

The server inserts landmarks or special structures at their determined coordinates and scales derived from known dimensions. When generating imaginary cities, the server positions floating structures and skybridges according to the configuration rule information, using procedural placement algorithms that treat existing buildings as anchor points and constraints.

### I. Optimization and Multi-Level Detail Management

The server optimizes the three-dimensional space information in the optimization unit. The server performs shape simplification by applying mesh decimation algorithms that reduce the number of vertices and faces while controlling error bounds. The server constructs multi-level detail structures by generating multiple decimated versions of each large object or region, each associated with a range of viewing distances.

The server compresses textures with GPU-friendly formats and generates mipmaps to improve cache efficiency and reduce aliasing during rendering. The server also segments the scene spatially using a quadtree or octree decomposition. Each node of the tree corresponds to a spatial tile containing a subset of geometry and textures.

The server then packages these tiles and levels of detail into streaming assets. The server creates manifest files that describe dependencies between tiles, LODs, and textures. The server configures thresholds and policies that determine which LODs are required based on the terminal's reported processing capabilities, including available GPU memory and supported texture compression formats.

This optimization process is not a mere abstraction. It changes the way data is represented and transmitted, thereby reducing network bandwidth, terminal-side memory usage, and draw call counts. As a result, the system can maintain higher frame rates and lower latency on devices with constrained resources compared to systems that transmit and render a single high-detail representation.

### J. Interaction and Technical Effects

The terminal receives the optimized assets and renders the environment using its GPU and a rendering engine. The terminal adjusts graphical settings, such as shadow quality and LOD bias, according to device capabilities reported to the server.

The user navigates through the environment using the terminal's input units. The terminal sends view position updates and region requests to the server. The server uses these updates to determine which spatial tiles and LODs are required, and the server streams only those assets, thereby reducing unnecessary data transmission.

The user may also issue voice commands. The terminal records audio, performs local or server-based speech recognition, and converts the audio into text. The server interprets the text not merely as a user interface event, but as new user designation information. The server updates the prompt sentences or configuration parameters and can regenerate or modify parts of the scene accordingly. For example, if the user says:

“Show a 19th-century version of this area with a focus on stone bridges and industrial warehouses,”

the server extracts this as a new constraint and adjusts the generation text information and subsequent generative AI model calls. This tight integration of user interaction with the analysis and generation loop improves responsiveness and allows the virtual environment to adapt computationally, not simply switch between pre-authored scenes.

### K. Technical Improvement Over Conventional Computer Processing

The server improves computer technology in several ways. First, by unifying feature extraction, prompt construction, generative AI inference, and optimization within a single processor-controlled pipeline, the server reduces redundant intermediate storage and conversions between disparate tools. The integrated pipeline minimizes the number of passes over data, reducing memory bandwidth consumption and improving throughput.

Second, the server uses prompt sentences that are automatically constructed from structured feature information, rather than static, human-authored prompts. This allows the generative AI model to be driven by precise numerical and categorical constraints extracted from image and geographic analysis. The resulting assets exhibit higher spatial and stylistic coherence with respect to the input data, reducing subsequent correction passes and manual editing. This leads to a measurable reduction in error rates for asset alignment and classification.

Third, the server's region-based segmentation and LOD streaming pipeline, combined with device capability feedback, optimize network usage and rendering load dynamically. The server responds to changes in user position and orientation by updating only the necessary tiles and LODs. This behavior is not equivalent to merely automating human content selection, but rather implements a non-trivial scheduling and data management strategy that leverages spatial indexing and performance profiling, improving frame stability and latency under variable conditions.

Fourth, the generative AI model is trained and used with explicit loss functions, optimization algorithms, and data augmentation methods that are chosen to capture architectural and urban patterns more accurately. The server may augment training data by applying transformations such as random crops, rotations, perspective distortions, and color jitter to increase robustness. The model's internal weights are updated using gradient-based optimization and backpropagation mechanisms, and the server periodically retrains or fine-tunes the model based on reconstructed scenes that are evaluated for quality. This closed-loop refinement is not a direct analog of human design but a data-driven improvement method that specifically targets computational generation quality.

### L. Variations and Alternative Embodiments

The server may adopt different neural network architectures, such as encoder-decoder networks with skip connections, attention-based transformers for sequence-to-image generation, or graph neural networks for modeling relationships between urban entities. The server may vary the loss functions, for example, combining pixel-level reconstruction losses with perceptual losses computed on feature activations of auxiliary networks, to improve visual fidelity.

The terminal may be a head-mounted display, a large-screen display system, or a vehicle-mounted display, and the sensor inputs may include inertial measurement units, eye-tracking sensors, or external tracking systems. The system may be deployed across distributed server clusters, where different nodes are responsible for analysis, generation, and streaming, but the logical units remain coordinated through shared data structures and service interfaces.

In all such embodiments, the server, the terminal, and the user interact through the specific data structures, generative AI models, and optimization pipelines described above, so that the system is not limited to abstract data manipulation, but rather implements a technically improved method for generating, optimizing, and rendering complex three-dimensional environments in a resource-efficient, responsive, and scalable manner.

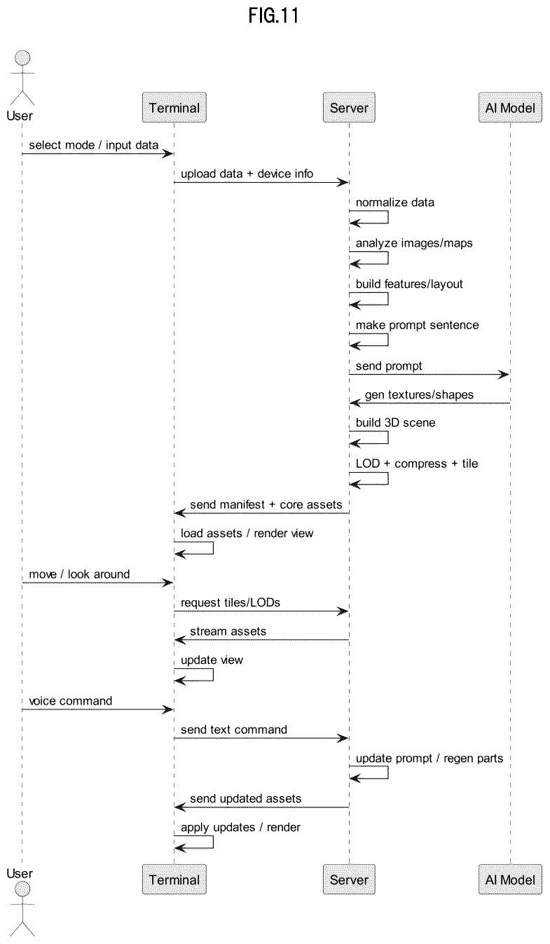

The following describes the processing flow using FIG. 11.

### Step 1:

The user selects a target environment and provides input data through the terminal.

The user chooses, on a graphical screen of the terminal, whether to reconstruct a historical city or to generate an imaginary environment. The user then uses the terminal camera to capture historical photographs, scanned maps, or concept art, or selects existing image files and geographic data from local or cloud storage.

Input: user selections (scenario type, era, region), captured or selected image files, downloaded map files, and current geographic coordinates from the terminal.

The terminal packages these items into a structured request containing binary image data, geographic coordinate values, and metadata such as file types and time periods.

Output: a request payload including images, geographic data, concept art, and metadata ready to be transmitted to the server.

### Step 2:

The terminal transmits the request payload to the server.

The terminal opens a secure network connection and sends the packaged data to a predefined server endpoint. The terminal may compress the payload, attach authentication tokens, and include device capability information such as available memory, screen resolution, and supported texture formats.

Input: the structured request payload produced in Step 1 and device capability metadata.

The terminal serializes this information into a network message and sends it using a communication protocol such as HTTPS.

Output: an incoming HTTP request received by the server, containing all user-provided input data and device capability information.

### Step 3:

The server receives and normalizes the input data.

The server parses the incoming request, validates file types and sizes, and stores raw image files and map files into persistent storage. The server converts all geographic coordinates into a common reference system and resizes or re-encodes images to a standard format and resolution range.

Input: the network message from the terminal containing images, maps, coordinates, and metadata.

The server performs data parsing, format conversion, and coordinate transformation on this input, and records associations between user identifiers, timestamps, and uploaded files in a database.

Output: normalized image datasets, normalized geographic datasets, and corresponding database records ready for analysis.

### Step 4:

The server performs image analysis and extracts low-level features.

The server loads each normalized image, applies edge detection and segmentation to separate buildings, roads, and background, and computes local texture descriptors and color histograms. The server generates building footprint candidates by grouping edge segments into closed polygons and estimates building heights by analyzing perspective lines and known reference scales.

Input: normalized image datasets produced in Step 3.

The server executes image processing algorithms and convolutional neural network inference on these images to transform pixel-level information into structured feature vectors describing shape, appearance, and approximate scale.

Output: a feature dataset of building outlines, façade textures, road candidates, and other visual features associated with spatial positions when available.

### Step 5:

The server performs geographic information processing and merges spatial data.

The server loads vector map layers and elevation data from the normalized geographic datasets, builds a road network graph from road centerlines, and computes urban blocks from the graph. The server also interpolates terrain elevation into a grid. The server then aligns building footprints derived from images with building polygons from the maps using spatial joins and distance thresholds.

Input: normalized geographic datasets from Step 3 and image-derived feature datasets from Step 4.

The server executes coordinate transformation, topological analysis, and spatial join operations to integrate image-based and map-based structures into a unified coordinate system.

Output: a coherent spatial feature dataset including roads, blocks, buildings, and terrain descriptors linked to common coordinates.

### Step 6:

The server classifies architectural styles and high-level attributes.

The server feeds image patches of building façades into a trained convolutional neural network that outputs probabilities for architectural style categories. The server assigns the most probable style label to each building and augments the feature dataset with attributes such as style type, floor count, window density, and roof type.

Input: façade image patches and building outlines from the spatial feature dataset of Step 5.

The server performs neural network inference and statistical aggregation on these inputs to convert raw visual patterns into labeled architectural attributes.

Output: an enriched feature dataset including architectural style labels and quantitative descriptors for each building.

### Step 7:

The server extracts high-level concept information for imaginary environments when concept art or text is present.

The server processes concept art images through an image encoder network to obtain latent vectors and processes user textual descriptions through a text encoder network. The server places these vectors into a shared embedding space, computes similarities and clusters, and maps clusters to semantic concepts such as floating structures, elevated gardens, and skybridges.

Input: concept art images and textual descriptions from the normalized input data of Step 3.

The server performs embedding computation, clustering, and label assignment to transform unstructured conceptual input into structured configuration rule information.

Output: high-level concept information and configuration rules specifying preferred object types, relative positions, and density patterns for fictional elements.

### Step 8:

The server constructs generation text information as prompt sentences.

The server composes one or more prompt sentences that describe the desired environment in natural language, combining architectural style labels, spatial layout constraints, time period, region, and high-level concepts. The server uses templates and rule-based phrase insertion to ensure the prompts encode concrete constraints for the generative AI model.

Input: enriched feature dataset from Steps 5 and 6, configuration rule information from Step 7, and user designation information (era, region, realism vs. imagination) from Step 1.

The server performs text construction and tokenization on these inputs to generate prompt sentences that encode style, layout, and content requirements.

Output: generation text information containing prompt sentences and associated tokens stored in a prompt dataset structure.

### Step 9:

The server generates assets using the generative AI model.

The server passes each prompt sentence, and optionally associated reference images or feature maps, into the generative AI model. The server initializes a generative process such as a diffusion denoising sequence and iteratively refines random noise into coherent images or shape hints conditioned on the text embeddings.

Input: prompt sentences from Step 8 and, optionally, reference feature maps or images from Steps 4 and 5.

The server executes generative inference algorithms that combine text conditioning and learned priors to transform abstract prompt text and feature constraints into concrete image information or three-dimensional shape information.

Output: generated textures, skyboxes, façade details, or structural hints that will be fused into the three-dimensional space information.

### Step 10:

The server constructs the three-dimensional environment geometry.

The server uses a three-dimensional engine or modeling API to create geometry for terrain, roads, and buildings. The server builds a triangulated terrain mesh from elevation grids, extrudes road centerlines into surface meshes, and extrudes building footprints to heights derived from the feature dataset. The server subdivides building faces into bays and floors and attaches UV coordinates for texture mapping.

Input: spatial feature dataset from Steps 5 and 6 and structural hints from Step 9 when available.

The server performs geometric computations, such as polygon extrusion and triangulation, to convert two-dimensional outlines and height values into three-dimensional vertex and index buffers.

Output: initial three-dimensional space information containing geometry for terrain, roads, buildings, and placeholders for textures and materials.

### Step 11:

The server applies textures and materials to the geometry.

The server assigns materials to each geometry object and binds generated textures to building façades, ground surfaces, and skyboxes. The server configures material parameters, including normal maps, roughness values, and color multipliers, and ensures that texture tiling and UV mapping are consistent with building proportions and street dimensions.

Input: generated image information from Step 9 and geometric meshes from Step 10.

The server executes material assignment, texture binding, and parameter configuration to convert plain geometry into visually detailed, render-ready objects.

Output: a visually complete three-dimensional space dataset with materials and textures bound to geometric structures.

### Step 12:

The server optimizes the three-dimensional space dataset for streaming and rendering.

The server performs mesh simplification to reduce polygon counts while maintaining perceived shape by computing error metrics for vertex removal. The server then generates multiple LOD variants for large objects and sets distance thresholds for each variant. The server compresses textures using device-compatible formats and generates mipmaps. The server partitions the scene spatially into tiles using a hierarchical structure and records which objects and LODs belong to each tile.

Input: fully textured three-dimensional space dataset from Step 11 and device capability information received in Step 2.

The server performs geometric decimation, LOD generation, texture compression, and spatial partitioning on this input, producing a hierarchy of assets optimized for different viewing distances and device capabilities.

Output: an optimized asset set consisting of tiled geometry, compressed textures, LOD hierarchies, and a manifest describing dependencies and streaming order.

### Step 13:

The server packages and transmits the optimized assets to the terminal.

The server groups tiles and LODs into asset bundles or files, generates manifest files listing checksums, dependencies, and spatial indices, and exposes URLs or streaming endpoints for each bundle. The server sends an initial manifest and core assets required for the starting viewpoint to the terminal, and remains ready to transmit additional bundles on demand.

Input: optimized asset set and manifest data produced in Step 12.

The server performs file packaging and network transmission to convert these internal asset structures into downloadable units addressed by the terminal.

Output: downloaded asset bundles and manifest information at the terminal side.

### Step 14:

The terminal loads assets and renders the initial view of the virtual environment.

The terminal parses the manifest, loads geometry, textures, and materials into its 3D engine, and sets up camera parameters and lighting according to scene metadata and device capabilities. The terminal initializes LOD systems and spatial culling mechanisms using the provided tile indices.

Input: asset bundles and manifest files received in Step 13.

The terminal performs file decoding, GPU buffer creation, shader setup, and scene graph initialization to convert static files into an interactive, renderable scene.

Output: a displayed initial view of the virtual environment on the terminal display, with internal state ready for user interaction and dynamic streaming.

### Step 15:

The user explores the environment and triggers dynamic streaming.

The user manipulates the terminal's touch screen, controller, or motion sensors to change viewpoint and move through the environment. The terminal interprets these inputs as camera transforms and updates the rendered view accordingly. As the user approaches new regions, the terminal requests specific tiles and higher LODs from the server based on the updated camera position and the manifest's spatial index.

Input: user interaction events and current camera position and orientation.

The terminal performs event handling and camera update computations, then generates asset requests that specify which tiles and LODs are now within the view frustum and distance thresholds.

Output: updated camera parameters for rendering and network requests to the server for additional or higher-detail assets.

### Step 16:

The server responds to dynamic asset requests and maintains performance.

The server receives tile and LOD requests from the terminal, identifies the required bundles from the manifest, and streams them in an order prioritized by proximity to the user's current viewpoint. The server may drop or throttle distant or low-priority tiles to preserve bandwidth.

Input: tile and LOD requests from the terminal produced in Step 15.

The server performs lookup operations in the manifest, prioritization based on distance or importance, and file streaming, thereby transforming static asset storage into a controlled flow of data adapted to current user position and device constraints.

Output: additional asset bundles delivered to the terminal, enabling progressively detailed rendering of nearby regions.

### Step 17:

The user issues voice commands to modify or regenerate the environment.

The user speaks instructions such as requests for a different historical period or for a future city variant. The terminal captures audio through the microphone, processes the signal, and converts it into a text string using speech recognition. The terminal sends this text as a new command to the server.

Input: audio waveform captured by the terminal microphone.

The terminal performs audio sampling and speech-to-text conversion to transform continuous speech into discrete textual commands compatible with server-side processing.

Output: a text command message delivered to the server representing the user's spoken request.

### Step 18:

The server updates prompt sentences and regenerates or modifies scene content.

The server interprets the text command as updated user designation information, adjusts the generation text information accordingly, and, if necessary, constructs new prompt sentences describing the requested changes (for example, new era, different landmark focus, or increased presence of fictional elements). The server calls the generative AI model again with updated prompts and, based on the new outputs, regenerates specific assets or modifies parts of the three-dimensional space dataset.

Input: text command from Step 17 and existing feature datasets, configuration rules, and prompt sentences from prior steps.

The server performs natural language parsing, prompt reconstruction, and targeted generative inference to convert the user's high-level modification request into updated images, textures, or geometry.

Output: updated assets and modified three-dimensional space information that reflect the new user requirements, ready to be re-optimized and streamed.

### Step 19:

The terminal receives updated assets and applies live scene updates.

The terminal downloads the updated bundles or delta assets from the server and replaces or overlays the corresponding geometry and textures in the local scene graph. The terminal ensures that in-flight camera transitions remain smooth by blending old and new assets where necessary.

Input: updated asset bundles and modification instructions from Step 18.

The terminal performs asset hot-loading, memory management, and state synchronization to transform the existing displayed environment into one that incorporates regenerated or modified elements without restarting the application.

Output: an updated virtual environment displayed on the terminal that reflects the user's new or refined request, maintaining interactive performance and visual continuity.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional systems for generating three-dimensional virtual environments from historical data and geographic data typically rely on fixed procedural rules or static simulation engines. These systems suffer from several technical limitations when deployed on distributed computer architectures involving a server and one or more user terminals.

First, in many existing systems, the conversion from heterogeneous spatiotemporal data (such as historical imagery, traffic measurements, population statistics, and environmental observations) into a three-dimensional virtual environment is performed by ad hoc pipelines that do not dynamically adapt to user objectives or changing conditions. The mapping from analyzed data to scene content is embedded in application-specific code, and the system cannot flexibly reconfigure the scene without re-running expensive end-to-end processing. As a result, the overall computer system exhibits high latency and poor responsiveness when users attempt to iteratively explore alternative future scenarios.

Second, typical three-dimensional content delivery mechanisms send monolithic assets or coarse-granularity scene bundles from a server to a terminal. Such mechanisms do not exploit fine-grained spatial partitioning or level-of-detail control that is coordinated with user viewpoint and interaction context. Consequently, the communication subsystem and the rendering subsystem become bottlenecks: large data transfers overload the network, and the terminal's graphics processing unit must process unnecessary geometry and textures. This leads to increased bandwidth consumption, higher memory usage, and degraded frame rates, particularly in immersive applications such as virtual reality.

Third, interactive modification of a simulated future environment based on user input is often implemented on the client side using simple parameter toggles or precomputed variants, without any deep recomputation of the underlying design. When a user issues a complex instruction, such as increasing green areas in a specific district or changing transportation priorities, conventional systems either cannot reflect such instructions at a structural level or must regenerate an entire scene offline. This architecture prevents real-time, fine-grained updates and results in a rigid user experience that fails to support iterative design workflows.

Fourth, while generative AI models are increasingly used to synthesize content from prompt sentences, existing integrations typically treat the generative AI model as a detached content provider. They do not structure the prompt sentence based on systematically extracted urban tendencies, nor do they tightly couple the generative output with server-side spatial tiling, optimization, and incremental regeneration. This lack of architectural integration causes inefficiencies: generative outputs are underutilized, the server must perform redundant conversions, and the system cannot leverage the generative AI model for partial updates confined to specific spatial regions or object groups.

Accordingly, there is a need for an improved computer-implemented system that: (i) transforms heterogeneous historical and current urban data into structured tendencies on time and space axes; (ii) converts these tendencies and user-defined objectives into prompt sentences for a generative AI model so as to obtain machine-readable configuration information for a future environment; (iii) generates and optimizes a three-dimensional virtual space model in a tile-based, multi-level-of-detail format suitable for efficient streaming; and (iv) performs partial, region-specific regeneration in response to user voice and motion inputs, thereby enabling interactive, low-latency updates while reducing network load and processing overhead. Such a system should improve the functioning of the underlying computer technology, including server-side processing pipelines, data encoding, and client-side rendering and interaction.

The specific processing by the specific processing unit 290 of the data processing device 12 in Application Example 1 is realized by the following means.

The present invention provides a server comprising a processor configured to receive, via an input interface, past information data and current location information including a plurality of types of electronic data such as image data, location reference data, movement amount data, population statistical data, and environmental observation data; to integrate the received data and normalize the integrated data on a time axis and a spatial axis; to extract, by executing analysis logic, growth tendencies, movement tendencies, population tendencies, and environmental tendencies from the normalized data; to construct a prompt sentence that includes text information describing the extracted tendencies together with design conditions and evaluation conditions derived from user input; to input the constructed prompt sentence into a generative AI model through a model interface and to obtain, in response, machine-readable configuration information representing route elements, building elements, space elements, vegetation elements, and supply elements of a future environment; to generate, by executing scene generation logic, a three-dimensional virtual space model in which the elements defined by the configuration information are mapped to three-dimensional shapes and associated metadata; to divide the generated three-dimensional virtual space model into a plurality of spatial regions and a plurality of levels of detail, and to perform optimization including element number reduction, hierarchical level-of-detail generation, and compression so as to form presentation data units associated with respective regions and levels of detail; to control distribution of the presentation data units to one or more user terminals based on positions and viewpoints of users so as to selectively transmit only necessary regions and appropriate levels of detail; to receive voice instructions and motion instructions from the user terminals, to update the design conditions or evaluation conditions based on the instructions, and to reconstruct an updated prompt sentence including identification information of at least one designated area or element group; to input the updated prompt sentence into the generative AI model to obtain partial configuration information reflecting requested modifications; and to regenerate and re-optimize only a corresponding part of the three-dimensional virtual space model based on the partial configuration information and to provide updated presentation data units to the user terminals, while also managing sharing of the three-dimensional virtual space model and associated condition information among multiple user terminals to support a collaborative experience.

This enables an integrated, server-centric improvement of computer technology that dynamically couples data analysis, generative AI-based configuration synthesis, tile-based three-dimensional scene generation, and incremental region-specific regeneration, thereby reducing network traffic, lowering processing load on user terminals, and providing low-latency, interactive updates to complex virtual environments.

The term “past information data” refers to electronically stored data representing historical states of an environment, including but not limited to past images, maps, measurements, statistics, and records associated with earlier points in time.

The term “current location information” refers to electronically stored data indicating positions or areas in a coordinate space at a present or designated reference time, including but not limited to geographic coordinates, map tiles, and spatial indices.

The term “input unit” refers to a hardware or software component that receives data or commands from external sources, such as user terminals, storage devices, or network interfaces, and provides the received data or commands to a processor for further processing.

The term “analysis unit” refers to a hardware or software component that executes algorithms to normalize, correlate, and evaluate input data, and to derive higher-level features or tendencies from such input data.

The term “growth tendencies” refers to patterns or trends over time related to expansion or contraction of physical structures, land use, or other measurable aspects of an environment.

The term “movement tendencies” refers to patterns or trends over time related to flows or displacements of entities, such as vehicles, people, or goods, within a spatial region.

The term “population tendencies” refers to patterns or trends over time related to changes in population, such as density, distribution, or demographic characteristics, within a given area.

The term “environmental tendencies” refers to patterns or trends over time related to environmental factors, such as temperature, precipitation, pollution, or natural hazards, affecting a given region.

The term “prompt sentence” refers to a text or structured textual description that defines context, constraints, and objectives, and that is input to a generative AI model to obtain generated output responsive to the described context, constraints, and objectives.

The term “design conditions” refers to constraints, goals, or parameters specified for configuring a future environment, including but not limited to capacity requirements, functional requirements, spatial relationships, and performance targets.

The term “evaluation conditions” refers to criteria or metrics used to assess quality, effectiveness, or suitability of a generated environment, including but not limited to congestion levels, accessibility measures, environmental impact, and resource usage.

The term “generative AI model” refers to a computational model that generates content, such as text, structured data, or other representations, in response to a given input, by using learned patterns obtained from training data.

The term “configuration information” refers to machine-readable data that specifies components, attributes, and relationships of an environment or system, and that can be used to construct or modify a corresponding representation, such as a three-dimensional scene.

The term “configuration information acquisition unit” refers to a hardware or software component that issues prompts or requests to a generative AI model and receives corresponding configuration information as output.

The term “three-dimensional virtual space model” refers to a digital representation of an environment in three-dimensional space, comprising geometric data, spatial relationships, and associated metadata sufficient for graphical rendering or simulation.

The term “building elements” refers to data entities representing built structures, such as buildings or facilities, including information on location, dimensions, and functional classification.

The term “route elements” refers to data entities representing paths or networks for movement, such as roads, walkways, or transport lines, including information on geometry, connectivity, and usage attributes.

The term “space elements” refers to data entities representing open or enclosed areas within an environment, such as squares, plazas, corridors, or districts, including information on boundaries and intended uses.

The term “vegetation elements” refers to data entities representing natural or artificial plant-related features, such as parks, green belts, or tree lines, including information on spatial extent and type of vegetation.

The term “supply elements” refers to data entities representing infrastructure associated with provision of resources or services, such as energy, water, or communication, including information on locations, capacities, and connectivity.

The term “generation unit” refers to a hardware or software component that constructs a three-dimensional virtual space model from configuration information by creating geometric representations and associating metadata with those representations.

The term “spatial region” refers to a sub-area of a three-dimensional virtual space model defined by spatial boundaries, such as a tile, cell, zone, or sector, which can be processed or transmitted independently from other sub-areas.

The term “level of detail” refers to a representation of an object or region with a particular degree of geometric or visual complexity, where multiple representations at different resolutions may exist for the same object or region.

The term “optimization unit” refers to a hardware or software component that reduces computational, storage, or transmission costs associated with a three-dimensional virtual space model by performing operations such as geometry simplification, level-of-detail generation, and data compression.

The term “presentation data” refers to processed and encoded data derived from a three-dimensional virtual space model that is suitable for transmission to and rendering by a user terminal.

The term “experience control unit” refers to a hardware or software component that manages distribution of presentation data to user terminals and coordinates the timing and form of rendering and interaction functions executed at the user terminals.

The term “user terminal” refers to a computing device, such as a head-mounted display, personal computer, or mobile device, that receives presentation data from a server and executes rendering, input processing, and interaction for a user.

The term “voice instructions” refers to commands or requests expressed by a user in spoken form, captured by an audio interface, recognized as text or control data, and used to influence processing or configuration.

The term “motion instructions” refers to commands or requests expressed by user movements, such as gestures or controller actions, captured by motion sensors or input devices and interpreted as control data.

The term “regeneration control unit” refers to a hardware or software component that selects portions of configuration information or a three-dimensional virtual space model to be modified, invokes the generative AI model with updated prompt sentences, and orchestrates partial regeneration and re-optimization of the selected portions.

The term “collaboration control unit” refers to a hardware or software component that manages shared access to a three-dimensional virtual space model and associated condition information among multiple user terminals, including synchronization of positions, interactions, and annotations.

The term “machine-readable structured data” refers to data organized according to a predefined schema or format, such as a hierarchical or tabular structure, which can be parsed and processed programmatically without human interpretation.

The term “element number reduction processing” refers to processing that decreases the count of geometry elements or objects in a three-dimensional model while preserving perceptually important features, in order to reduce computational and storage requirements.

The term “hierarchical level-of-detail generation processing” refers to processing that creates multiple representations of the same object or region at different resolutions and organizes them in a structure that allows selection of an appropriate level of detail at runtime.

The term “compression processing” refers to encoding operations that reduce the size of data representing a three-dimensional virtual space model or presentation data, using lossless or lossy techniques to decrease required storage or transmission bandwidth.

The term “partial future environment plan” refers to configuration information generated for only a subset of an overall environment, such as a specific spatial region or element group, in response to focused prompt sentences or modification requests.

The term “annotation information” refers to data representing comments, markers, labels, or other metadata associated with specific locations, objects, or times in a three-dimensional virtual space model, typically contributed by one or more users.

In one embodiment, a server, a terminal, and a user cooperate to implement the claimed system. The server comprises at least one processor, a memory, a non-transitory storage device, and a network interface. The terminal comprises a processor, a graphics processing unit, an input interface including a microphone and motion sensors, and a display device such as a head-mounted display. The user operates the terminal to initiate simulation scenarios, to provide objectives, and to explore generated three-dimensional virtual spaces.

The server uses general-purpose computing hardware such as a multi-core central processing unit and, in some embodiments, an accelerator such as a graphics processing unit for neural network inference. The server executes software components including an operating system, a web server, an application framework, a database management system, and a generative AI model runtime. Examples of such software include a generic operating system, a web server implemented using a general-purpose HTTP server and an application layer framework, and a relational database such as a geospatially enabled database. The server further uses numerical computation libraries (for example, common array-processing libraries), geospatial processing libraries (for example, a general-purpose geospatial data abstraction library and a spatial extension of a relational database), and image processing libraries (for example, a general-purpose image processing library).

The terminal executes a visualization application using a real-time rendering engine, such as a general-purpose game engine supporting virtual reality, and a virtual reality runtime such as a cross-platform VR standard or a vendor-specific VR runtime. The terminal uses a web browser or a native application to communicate with the server via a network, for example over HTTPS.

The server receives past information data and current location information from the terminal.

The user selects and uploads data including historical images, maps, traffic logs, population statistics, and environmental measurements using a user interface on the terminal. The terminal sends these data sets as electronic files (for example, raster image files, vector geospatial layer files, comma-separated value files, and scientific data files) through an upload interface to the server. The server stores the received files in a storage system, such as object storage for large binary files, and registers metadata, including data type, spatial reference system, temporal coverage, and scenario identifier, in the database.

The server performs data preprocessing using the processor and memory. The server uses the geospatial processing library to transform each geospatial dataset into a common coordinate reference system. The server uses the image processing library to adjust resolution, normalize pixel values, and detect basic structures such as edges and homogeneous regions. The server uses numerical computation libraries to load and validate tabular datasets, to convert units where necessary, and to align all time-series data to a common set of temporal indices. The server writes normalized data into structured tables in the database, such as a table of raster tiles indexed by spatial and temporal keys and tables of time-series data indexed by region and time.

The server then extracts growth tendencies, movement tendencies, population tendencies, and environmental tendencies. The server executes analysis logic implemented as database queries and numerical computation functions. For example, the server computes urban growth tendencies by performing change detection on a sequence of land-use rasters, using pixel-wise difference operations and morphological filters provided by the image processing library. The server computes movement tendencies by aggregating traffic counts per road segment and time interval, calculating derived metrics such as peak-hour volume-to-capacity ratios and identifying statistically persistent congestion patterns. The server computes population tendencies by interpolating census data across time, computing per-region density, and evaluating growth or decline rates. The server computes environmental tendencies by loading environmental measurements, such as temperature and precipitation, and fitting regression models or computing long-term averages and anomalies for each region.

The server assembles the extracted tendencies into an internal data structure, for example a set of feature vectors and spatial graphs. Each feature vector may include descriptors such as average building height, built-up area ratio, traffic volume statistics, population density, and environmental risk scores for a specific region and time. The server stores these feature vectors in the database with references to corresponding spatial regions.

The server constructs a prompt sentence for a generative AI model by combining descriptive text templates with values derived from the feature vectors and user-specified design conditions. The server uses a template engine or string processing library to fill in placeholders with actual numerical and categorical values. For example, the server constructs a prompt sentence such as:

“To simulate the urban environment in 2050 for a coastal metropolitan region, based on historical urban growth from 1970 to 2020, current congestion hotspots on main arterial corridors, a projected 30% population increase, and an expected average temperature rise of 2 degrees Celsius, design a future transportation and land-use configuration. Include high-capacity public transit corridors, dedicated lanes for autonomous vehicles, bicycle networks, green corridors, and distributed renewable energy hubs. Describe the layout as a structured set of road segments, building zones, green areas, and energy facilities, including relative positions, capacities, and intended functions.”

In another example, the server constructs a prompt sentence such as:

“Considering a projected population increase of 100,000 residents by 2050 and current land-use and environmental constraints, generate a sustainable residential district layout that ensures at least 30 percent green space, that places all residents within 500 meters of a public transit stop, and that includes mixed-use zones supporting local employment. Describe building blocks, heights, land-use categories, green corridors, and distributed energy systems in a structured manner suitable for three-dimensional visualization.”

The server applies a generative AI model that is implemented as a neural network architecture, such as a transformer-based sequence model or a hybrid model combining sequence processing layers with graph-based encoders. In one embodiment, the server uses a transformer encoder-decoder architecture having multiple attention layers, feed-forward layers, and normalization layers. The server configures the model with parameters including the number of layers, hidden dimensions, attention heads, and activation functions. The server loads trained model weights from a model repository. These weights are obtained by supervised or self-supervised training on large corpora of urban design descriptions, geospatial configurations, and annotated layouts.

The server feeds the constructed prompt sentence into the generative AI model via a model runtime library. The server encodes the prompt sentence into token sequences, applies positional encodings, and processes the sequences through the neural network to produce output tokens. The model internally computes attention scores that capture relationships between different parts of the prompt, such as constraints on population, transportation, and environment. The model outputs a structured text description or a serialized structured representation (for example, a well-formed text that can be parsed into a list of elements and attributes). The server uses a parser to convert the output into configuration information, which may be represented as a hierarchy of elements including route elements, building elements, space elements, vegetation elements, and supply elements, each element having attributes such as coordinates, size, capacity, usage type, and relationships to other elements.

The server improves computer technology by using a specific, non-conventional integration of the generative AI model with structured tendency extraction and tile-based three-dimensional model generation. Unlike simple automation of manual drafting, the server uses feature vectors and spatial graphs as inputs to the model, and uses the model's output to directly control generation of optimized, tile-partitioned three-dimensional assets. The server thereby reduces redundant recalculation by enabling region-specific updates and reduces network load by coordinating model output with level-of-detail partitioning.

The server generates a three-dimensional virtual space model from the configuration information using a three-dimensional content generation engine. The server creates geometric primitives such as meshes for buildings, roads, parks, and infrastructure based on the element attributes. The server uses procedural modeling algorithms that interpret element parameters to decide heights, widths, façade patterns, and layout compositions. For example, the server applies road extrusion algorithms to create road meshes with specified lane counts and widths along polyline paths. The server applies building footprint polygons and height attributes to generate building meshes with appropriate volumes. The server attaches metadata to each mesh, including its identifier, land-use category, and performance metrics, in a data structure accessible during rendering.

The server partitions the three-dimensional virtual space model into spatial regions, such as tiles organized in a grid or quadtree structure. The server assigns each object to one or more tiles based on spatial overlap and computes bounding volumes for culling. The server, for each tile, generates multiple levels of detail. A high level of detail may include fine-grained geometry and high-resolution textures, whereas a low level of detail may include simplified meshes and lower-resolution textures. The server uses mesh simplification algorithms, for example edge collapse or vertex clustering, and texture downsampling techniques to produce these levels.

The server performs optimization on each tile and level of detail. The server applies element number reduction processing by merging nearby static objects into batch meshes where feasible and by removing sub-pixel details that are not perceptible at given viewing distances.

The server applies compression processing, for example by using a mesh compression algorithm for geometry and a texture compression format for textures, and by applying general-purpose data compression for network transmission. The server stores the optimized tile assets on the storage device, together with metadata describing tile indices, levels of detail, and dependencies.

The server distributes presentation data to the terminal based on user position and viewpoint. The terminal periodically sends its current position and orientation in the virtual space to the server. The server computes which tiles and which levels of detail are required based on a visibility and distance computation. The server responds with a list of required tiles and provides corresponding compressed assets. This tile-based selective transmission reduces communication load, memory usage, and rendering overhead on the terminal. The terminal loads and decodes the assets into GPU memory using the rendering engine, and uses culling and level-of-detail selection to render an immersive view at high frame rates.

The user experiences the future environment through the terminal. The terminal receives head pose data from the head-mounted display sensors and controller or hand-tracking data as motion inputs. The terminal maps these motion inputs to camera movements, teleportation operations, or direct manipulations of objects in the three-dimensional virtual space. The terminal receives voice signals via the microphone and uses a speech recognition engine to convert the audio into text commands. The terminal sends recognized voice instructions and motion instructions to the server, including context such as the currently selected spatial region or object identifier.

The server interprets the voice instructions and motion instructions and updates the design conditions or evaluation conditions accordingly. For example, when the user issues a command such as “Increase green space in this district and reduce private car lanes,” while pointing at a district, the terminal transmits a request containing the district identifier and the command text. The server updates a condition record associated with that district to increase minimum green-space ratio and decrease maximum private vehicle lane count. The server then reconstructs a new prompt sentence that includes a description of the existing configuration, the updated conditions for the specified district, and other constraints that should remain fixed.

An example prompt sentence for such an update may be:

“For the currently simulated district in the northeastern quadrant of the city, where the existing plan includes four-lane private vehicle roads and 10 percent green area, modify the configuration to increase the green area to at least 30 percent and to reduce private vehicle lanes in favor of bicycle lanes and public transport. Maintain the existing building capacity and keep the overall population and energy targets unchanged. Output an updated configuration for only this district, including revised road types, park locations, and associated parameters.”

The server inputs the updated prompt sentence into the generative AI model. To support efficient partial updates, the server provides the model with a representation of the current configuration for that district as additional context tokens or appended descriptions. The model outputs a partial future environment plan for the district. The server parses the plan, updating only those route elements, vegetation elements, and possibly building placement attributes that are marked as changed. The server regenerates only the meshes and assets for the affected tiles and levels of detail, re-applies optimization and compression to these updated tiles, and marks them as updated in the storage device.

The server sends notifications to the terminal that updated tiles are available. The terminal selectively downloads and replaces the affected tiles in the rendering engine at runtime. As a result, the user perceives a seamless transition in the virtual space where roads and green spaces change according to the voice command, without requiring complete reloading of the scene. This partial regeneration mechanism improves responsiveness and reduces the amount of data transferred and processed.

The server improves the functioning of the computer system by introducing an architecture in which data analysis, generative synthesis, and three-dimensional rendering are tightly integrated. The extraction of tendencies into feature vectors reduces the dimensionality and redundancy of raw data before it is used in prompt sentences, which shortens inference time for the generative AI model and improves the relevance of generated configurations. The tile-based, multi-level-of-detail organization of the three-dimensional virtual space model, coordinated with user position and viewpoint, reduces bandwidth and rendering workload, enabling higher frame rates and lower latency on the terminal. The selective, region-specific regeneration controlled by updated prompt sentences avoids recomputing and retransmitting the entire scene, which reduces computational cost and improves interactivity.

In another embodiment, the server uses a different generative AI model structure, such as a graph neural network that operates on a graph representation of the urban environment. The server encodes roads, parcels, and facilities as graph nodes and edges, with attributes derived from the tendencies and design conditions. The graph neural network propagates features across the graph and outputs updated node and edge attributes representing a future configuration. The server then converts the updated graph into configuration information and proceeds with three-dimensional generation and optimization in the same manner as the transformer-based embodiment. Such a graph-based model can capture relational constraints more directly, which may improve accuracy of connectivity and accessibility metrics.

In a further embodiment, the server implements different optimization strategies, such as dynamically adjusting compression parameters based on network conditions reported by terminals. The server monitors round-trip latency and throughput for each terminal and selects higher compression ratios and lower levels of detail when bandwidth is constrained, or lower compression ratios and higher levels of detail when bandwidth is sufficient. This adaptive control of compression and level of detail further reduces perceived latency and improves user experience.

In another variation, the terminal performs a portion of the analysis and generation tasks locally. For example, the server may send intermediate configuration information at an abstract level, and the terminal may use a local procedural modeling module to generate certain decorative geometries or fine-grained details based on device-specific performance profiles. The terminal thereby tailors content to local capabilities while the server maintains control over global layout and data consistency. This split processing can distribute computational load and further improve scalability across many terminals.

The server, by structuring data into tiles, feature vectors, and configuration elements, and by coordinating generative synthesis with these structures, achieves technical effects such as faster access times, reduced memory footprint, improved cache locality during rendering, and lower cumulative error compared to ad hoc, monolithic scene generation. The system is not limited to automating human decision-making; rather, the system alters the internal operation of the computing architecture by introducing specific data structures and processing flows that enhance processing speed, precision of spatial alignment, efficiency of transmission, and quality of real-time rendering.

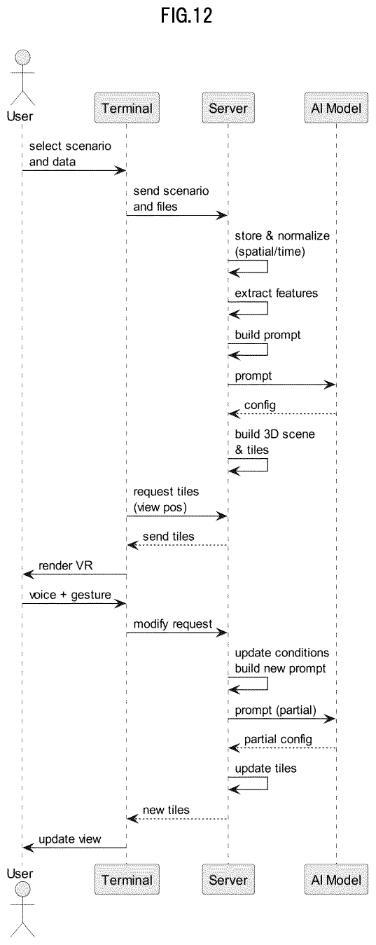

The following describes the processing flow using FIG. 12.

### Step 1:

User operates the terminal to select a target region, a historical time range, and a target future year, and to specify design objectives.

User uses a graphical user interface on the terminal to choose parameters such as city name, past data period (for example, 1970-2020), and target simulation year (for example, 2050), and to set objectives such as congestion reduction, green area increase, or public transport promotion.

Input: user selections and design objectives.

Terminal converts the user selections into a structured request, for example a JSON object containing identifiers of the region, temporal bounds, and objective flags, and sends this request to the server via a network interface.

Output: a scenario initialization request transmitted from the terminal to the server.

### Step 2:

Terminal acquires and transmits source data files to the server.

User selects local data files on the terminal, such as raster images, vector layers, traffic logs, population tables, and environmental measurements.

Input: user-selected digital files and associated metadata (file paths, formats).

Terminal reads the digital files from local storage, determines file types (for example, raster, vector, CSV, scientific data), and attaches metadata including approximate coordinate systems, timestamps, and data categories. Terminal then uploads these files to the server using an HTTP or similar protocol, embedding binary file streams and metadata in a request payload.

Output: an upload request containing raw data files and metadata sent to the server.

### Step 3:

Server receives and stores the uploaded data and metadata.

Server accepts the upload request via a network interface and validates file types, sizes, and authentication information.

Input: raw file streams and metadata from the terminal.

Server writes each file into persistent storage, such as object storage or a file system, and creates database entries linking file identifiers to the scenario identifier, data type, coordinate system, and temporal coverage. Server records this information in relational tables, enabling subsequent lookup and processing.

Output: registered dataset records in the server database and stored raw data files.

### Step 4:

Server normalizes spatial coordinates and temporal indices of the received data.

Server retrieves raw data file paths and metadata from the database and uses geospatial and numerical libraries to standardize them.

Input: raw files and associated metadata, including original coordinate reference systems and timestamps.

Server converts all geospatial datasets (for example, maps, satellite images, road networks) into a single common coordinate reference system by applying coordinate transformation functions. Server resamples rasters to a selected spatial resolution and performs temporal alignment by mapping timestamps into uniform intervals (for example, yearly buckets).

Server stores normalized rasters and vector geometries in structured storage, indexed by tile coordinates and time indices.

Output: normalized spatial and temporal datasets organized by scenario, region, and time interval.

### Step 5:

Server extracts feature vectors describing urban growth, movement, population, and environment.

Server reads normalized datasets and executes analysis algorithms to compute higher-level descriptors.

Input: normalized rasters, normalized vector layers, aligned traffic logs, population tables, and environmental time series.

Server applies difference operations on sequential land-use rasters to compute changes in built-up area per region, then aggregates results to obtain urban growth metrics such as growth rate and expansion direction. Server aggregates traffic volumes per road segment and time interval, and calculates derived features such as average peak-hour traffic, congestion indices, and reliability scores. Server interpolates population counts over time and computes density and growth rates per region. Server calculates environmental metrics such as long-term temperature trends and precipitation anomalies. Server encodes all such metrics into numerical feature vectors associated with specific spatial regions and time intervals, and stores them in database tables keyed by region and time.

Output: a set of feature vectors and associated spatial indices representing growth tendencies, movement tendencies, population tendencies, and environmental tendencies.

### Step 6:

Server constructs a prompt sentence for a generative AI model based on feature vectors and design objectives.

Server queries the database for feature vectors corresponding to the scenario and retrieves the user-provided design objectives.

Input: feature vectors, region identifiers, and design objectives from the scenario record.

Server uses text templates with placeholders for numeric and categorical values and fills them with data from the feature vectors (for example, population increase percentages, congestion levels, environmental trends) and user objectives (for example, minimum green-space ratio, target congestion reduction). Server concatenates these filled templates into a coherent prompt sentence that describes the current conditions, projected trends, constraints, and requested outputs.

Output: a fully constructed prompt sentence and optionally auxiliary structured context to be supplied to the generative AI model.

### Step 7:

Server submits the prompt sentence to the generative AI model and obtains configuration information for a future environment.

Server encodes the prompt sentence as tokens and processes it through a neural network model.

Input: prompt sentence and optional auxiliary context derived from feature vectors (for example, embedded vectors or appended summaries).

Server uses a generative AI model, such as a trained transformer or graph-based neural network, loaded into memory with pre-trained weights. Server applies tokenization, adds positional encodings, and runs the model forward pass to generate an output sequence. The model computes internal attention and non-linear transformations based on the prompt content, then outputs a structured textual description that encodes road types, building zones, green areas, and supply infrastructures with attributes and relationships. Server parses the generated text into a machine-readable configuration structure, creating a list of elements (route elements, building elements, space elements, vegetation elements, and supply elements) with fields such as position, dimension, capacity, and usage type.

Output: configuration information representing the future environment in a structured, machine-readable format.

### Step 8:

Server generates a three-dimensional virtual space model from the configuration information.

Server translates each abstract element into geometric primitives and metadata suitable for rendering.

Input: configuration information including lists of elements and their attributes.

Server maps route elements to three-dimensional meshes by extruding line geometries into multi-lane roads with cross-sections determined by lane counts and widths. Server maps building elements to volumetric meshes using footprint shapes and height attributes. Server maps space elements and vegetation elements to ground patches and vegetation objects with assigned textures and models. Server attaches attributes such as land-use category, density, and energy metrics to each object as metadata. The three-dimensional engine organizes these meshes and metadata into a scene graph or equivalent structure representing the entire simulated future environment.

Output: an initial three-dimensional virtual space model with geometry and metadata for all configured elements.

### Step 9:

Server partitions the three-dimensional virtual space model into spatial regions and levels of detail and performs optimization.

Server analyzes the spatial extent of the scene and divides it into tiles or regions, then generates multiple resolutions per region.

Input: global three-dimensional scene graph and object metadata.

Server assigns each object to one or more spatial tiles by evaluating spatial overlap with tile boundaries. For each tile, server generates multiple levels of detail by applying mesh simplification and texture reduction schemes, creating low-, medium-, and high-resolution versions of the tile content. Server further performs element number reduction by merging static objects into batch meshes where beneficial and prunes geometry that falls below a perceptual threshold at given distances. Server compresses meshes and textures, and writes each tile and level-of-detail asset to storage, along with metadata containing tile identifiers, level-of-detail values, and bounding volumes.

Output: a set of optimized, compressed tile assets with associated metadata representing the three-dimensional virtual space model in a tiled, multi-level-of-detail format.

### Step 10:

Terminal requests and receives appropriate tiles based on user position and viewpoint.

Terminal tracks the user's location and orientation in the virtual space during interaction.

Input: tile metadata from the server and real-time user pose data captured by the terminal's sensors.

Terminal determines which spatial regions fall within or near the user's field of view and sends a tile request to the server specifying region identifiers and desired levels of detail.

Server responds by transmitting compressed tile assets that correspond to those regions.

Terminal decompresses the received assets, loads meshes and textures into the rendering engine, and inserts them into the local scene representation.

Output: locally stored, decoded three-dimensional assets ready for rendering at the terminal.

### Step 11:

Terminal renders the three-dimensional virtual space and captures user interactions.

Terminal uses its graphics processing unit and rendering engine to generate frames for display to the user.

Input: loaded three-dimensional assets, user pose data, and interaction events from controllers or hand tracking.

Terminal applies camera transformations based on head pose, performs culling and level-of-detail selection, and renders the visible tiles to the display. Terminal interprets controller inputs and gestures as navigation actions (for example, walking, teleporting, rotating) or selection actions (for example, pointing at an object and pressing a button). Terminal displays context-sensitive information when the user selects elements, such as building or road details retrieved from object metadata.

Output: rendered images presented to the user and a stream of interaction events reported back to the server.

### Step 12:

Terminal acquires voice instructions and motion instructions from the user and sends modification requests to the server.

User issues verbal commands and gesture-based selections while viewing the future environment.

Input: user speech captured by the microphone and motion data captured by controllers or motion sensors.

Terminal converts audio signals into text using a speech recognition engine, synchronizes the recognized text with the currently pointed-at or selected region or object, and encapsulates this combination into a modification request. Terminal sends the modification request, including scenario identifier, region or element identifiers, and command text, to the server via the network.

Output: a structured modification request that indicates user-intended changes for specific regions or elements of the environment.

### Step 13:

Server updates design conditions and reconstructs an updated prompt sentence for partial regeneration.

Server receives the modification request and determines how it alters design constraints.

Input: modification request containing command text and region or element identifiers.

Server parses the command text, maps it to parameter changes (for example, increase minimum green area, reduce automobile lanes, raise public transit capacity), and updates corresponding condition records in the database for the targeted region or element group.

Server then constructs a new prompt sentence, describing existing configuration details for the targeted region, the updated conditions, and constraints that must remain unchanged. Server is careful to limit the requested changes to the identified subset of the environment, and the prompt sentence explicitly instructs the generative AI model to output only partial configuration information for the affected area.

Output: an updated, region-specific prompt sentence reflecting user-requested changes.

### Step 14:

Server performs partial generation with the generative AI model and updates affected parts of the three-dimensional virtual space model.

Server sends the updated prompt sentence to the generative AI model along with context on the existing configuration in the targeted region.

Input: updated prompt sentence and current configuration information for the targeted region.

Server invokes the generative AI model to produce a revised partial future environment plan, which contains updated route elements, vegetation elements, and potentially modified building or space elements for the specified region. Server parses the partial plan, updates the configuration information in the database for only the affected elements, and regenerates corresponding meshes and textures for the affected tiles. Server then re-applies optimization and compression for those tiles and updates their metadata.

Output: updated tile assets and configuration information for the affected spatial regions.

### Step 15:

Terminal receives updated tiles and applies live updates to the rendered environment.

Terminal is notified that new versions of certain tiles are available.

Input: notification from the server containing identifiers of updated tiles and their asset locations.

Terminal requests and downloads the updated tile assets, unloads old versions from the rendering engine, and loads the new versions in their place. Terminal ensures continuity by synchronizing the replacement with frame boundaries and preserving user position and orientation. As a result, the terminal shows the updated environment that reflects user commands, such as increased green areas or modified road structures, without reinitializing the entire scene.

Output: an interactively updated visualization of the future environment displayed to the user.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional systems for generating three-dimensional virtual environments from past image information and geographic information typically rely on static, designer-authored rules and fixed rendering pipelines. Such systems generally treat user input as a one-time configuration (for example, selection of a city or era) and then generate a virtual city space that is identical for all users. As a result, the generation of three-dimensional virtual city space data is not adapted to the individual user's emotional state, and the rendering workload and data volume are not dynamically optimized in view of changing user engagement during the experience.

In particular, known computer-implemented techniques often exhibit several technical drawbacks. First, the content generation pipeline is decoupled from any real-time analysis of user signals such as facial expressions, voice characteristics, and interaction patterns. The underlying computing architecture therefore cannot utilize these signals to adjust the complexity, atmosphere, or event density of the generated scene, resulting in inefficient use of processing resources and network bandwidth for users who are, for example, bored, anxious, or already highly engaged.

Second, when a generative artificial intelligence model is used to create images or three-dimensional shapes from text, the prompt sentences supplied to the model are usually static templates written in advance. Such prompt sentences are not automatically updated according to computationally inferred emotion states, nor are they systematically linked to structured building shape information and urban layout information derived from large-scale image and geographic data. This separation leads to suboptimal prompt design, wasted inference cycles on scenes that do not match user needs, and poor controllability of the generative model in terms of spatial consistency and level of detail.

Third, conventional virtual city rendering systems treat optimization (for example, polygon reduction and texture compression) as a one-time pre-processing step, rather than as a component of an integrated control loop that continually reacts to user state and device capability. The absence of a feedback loop between emotion analysis, prompt generation, generative AI inference, and streaming of differential scene updates impairs the system's ability to maintain high frame rates and perceptual quality on resource-constrained terminal devices.

Accordingly, there is a need for improved computer technology that tightly integrates: (i) multimodal emotion analysis on the server, (ii) dynamic generation of prompt sentences for a generative AI model based on structured scene information and emotion states, and (iii) incremental synthesis and optimization of three-dimensional virtual city space data that is adaptively streamed to terminal devices. Such a system should enable the processor to use emotion-derived control signals as first-class inputs in the content generation and optimization pipeline, thereby improving responsiveness, computational efficiency, and quality of experience in three-dimensional virtual city environments.

The specific processing by the specific processing unit 290 of the data processing device 12 in Example 2 is realized by the following means.

The present invention provides a server comprising a processor configured to: receive, from an input device, input information including past image information and geographic information; execute image processing and geographic information processing on the past image information and the geographic information to extract building shape information representing three-dimensional shapes of structures and urban layout information representing spatial arrangement relationships of components in an urban space; acquire, from a terminal device, emotion-related information including facial image information, audio information, and operation history information of a user; analyze the facial image information, the audio information, and the operation history information using one or more machine learning models to calculate emotion indices of the user and estimate a multi-dimensional emotion state of the user; generate a prompt sentence for input to a generative artificial intelligence model based on the building shape information, the urban layout information, the estimated emotion state, and usage information indicating a usage purpose; input the prompt sentence as text to the generative artificial intelligence model and generate three-dimensional virtual city space data including at least structures, roads, terrain, and characters based on an inference process of the generative artificial intelligence model; optimize the three-dimensional virtual city space data by performing at least polygon count reduction, texture compression, and multi-level resolution setting to generate lightweight data according to a display load of the terminal device; and transmit the lightweight three-dimensional virtual city space data to the terminal device and cause the terminal device to perform display control and viewpoint control of a three-dimensional virtual city space using a display device and a position and posture detection device. This enables the computing system to close a feedback loop between multimodal emotion analysis, dynamic prompt sentence generation for a generative AI model, and adaptive optimization and streaming of three-dimensional virtual city data, thereby improving computational efficiency, reducing rendering and transmission overhead on terminal devices, and providing a technically enhanced, emotion-adaptive virtual city experience.

The term “past image information” refers to digital image data representing past or historical scenes, including but not limited to photographs, scanned documents, maps, and other visual records that depict buildings, roads, terrain, or other elements of an urban environment at a previous time.

The term “geographic information” refers to digital data that includes spatial coordinates and attributes of geographic features, such as roads, buildings, rivers, and terrain, and that may be represented in formats including but not limited to vector data, raster data, and structured geographic data formats.

The term “input device” refers to any hardware or software component configured to accept input information from a user or an external source and to transmit the input information to a server or information processing apparatus, and includes, for example, a terminal device, a sensor module, or a user interface application.

The term “information processing apparatus” refers to an electronic computing device or system comprising at least one processor and memory, configured to execute instructions for processing data, including servers, data centers, and distributed computing systems.

The term “building shape information” refers to structured data representing three-dimensional geometric characteristics of a structure, including but not limited to height, width, roof type, façade contours, window arrangements, and other parameters used to model the external shape of the structure.

The term “urban layout information” refers to structured data representing spatial arrangement relationships among components in an urban space, including but not limited to the connectivity and position of roads, intersections, open spaces, water bodies, and groups of structures within a coordinate system.

The term “terminal device” refers to an electronic device operated directly or indirectly by a user to experience a three-dimensional virtual city space, including but not limited to mobile terminals, head-mounted displays, tablet devices, and personal computers.

The term “emotion-related information” refers to data associated with the emotional state or reaction of a user, including but not limited to facial image information, audio information capturing user voice or sound, and operation history information representing user interaction patterns.

The term “facial image information” refers to image data containing at least a region corresponding to the face of a user, captured by an imaging device and processed in a digital form suitable for facial analysis.

The term “audio information” refers to digital representations of sound captured from a user or an environment, including but not limited to voice signals sampled and encoded by an audio input device.

The term “operation history information” refers to data representing user interactions with a terminal device over time, including but not limited to gesture events, input commands, viewpoint changes, and associated timestamps and locations within a user interface or virtual environment.

The term “emotion indices” refers to numerical or categorical values computed from emotion-related information that quantify aspects of a user's emotional condition, such as pleasantness, arousal, interest, anxiety, or boredom.

The term “emotion state” refers to a multi-dimensional representation of a user's emotional condition, expressed as a vector or set of indices including at least one of pleasantness, arousal, interest, anxiety, and boredom.

The term “usage information” refers to data indicating an intended use or purpose of a three-dimensional virtual city space, including but not limited to educational use, entertainment use, or sightseeing use.

The term “prompt sentence” refers to a sequence of natural-language text or other symbolic instructions provided as input to a generative artificial intelligence model to specify desired content, style, conditions, and constraints of generated output.

The term “generative artificial intelligence model” refers to a machine learning model configured to generate data, such as images, three-dimensional shapes, or other content, based on input instructions including text, and includes but is not limited to deep neural network models that perform text-to-image or text-to-three-dimensional generation.

The term “three-dimensional virtual city space data” refers to digital data that defines a three-dimensional representation of an urban environment, including but not limited to geometric models of structures, roads, terrain, and characters, as well as associated textures, materials, lighting parameters, and camera configurations.

The term “polygon count reduction” refers to a processing technique that reduces the number of polygons or geometric primitives in a three-dimensional model while maintaining an approximation of its visual appearance, thereby decreasing computational load and data size.

The term “texture compression” refers to a processing technique that encodes texture image data into a more compact representation, potentially with reduced resolution or lossy compression, to reduce memory and bandwidth requirements while maintaining acceptable visual quality.

The term “multi-level resolution setting” refers to a configuration in which multiple versions of three-dimensional models or textures are prepared at different levels of detail or resolution, such that an appropriate version can be selected at runtime based on device capabilities, viewing distance, or performance conditions.

The term “lightweight data” refers to three-dimensional virtual city space data that has been optimized to reduce computational complexity, memory usage, and transmission size relative to an unoptimized version, while preserving sufficient quality for rendering on a target device.

The term “display load” refers to the amount of computational, memory, and bandwidth resources required by a terminal device to render and display a three-dimensional virtual city space, including the processing required for graphics operations and user interaction.

The term “display control” refers to processing that manages how a three-dimensional virtual city space is rendered and presented on a display device of a terminal, including camera positioning, frame update scheduling, and scene composition.

The term “viewpoint control” refers to processing that determines the position and orientation of a virtual camera in a three-dimensional virtual city space based on user input, device motion, or other control signals, thereby defining the user's perspective of the scene.

The term “position and posture detection device” refers to a sensor or combination of sensors configured to detect at least one of a location, orientation, or motion of a terminal device or a user, including but not limited to inertial sensors, global navigation satellite system receivers, or optical tracking systems.

The term “machine learning model for facial expression recognition” refers to a trained computational model that receives facial image information as input and outputs probabilities or labels associated with predefined facial expression categories.

The term “audio emotion recognition model” refers to a trained computational model that receives acoustic feature quantities extracted from audio information and outputs estimates of emotional attributes such as arousal or valence.

The term “behavioral analysis model” refers to a trained computational model that receives operation history information or derived behavioral feature quantities as input and outputs indicators related to user engagement, such as interest or boredom.

The term “integration model” refers to a computational model configured to combine multiple emotion-related indices obtained from different modalities, such as facial image information, audio information, and operation history information, into a unified emotion state vector.

The term “emotion state vector” refers to a structured numerical representation of a user's emotional condition in a multi-dimensional space, each dimension corresponding to a specific emotional attribute such as pleasantness, arousal, interest, anxiety, or boredom.

The term “time of day” refers to a condition parameter in a prompt sentence that specifies a temporal setting of a virtual city scene, such as morning, daytime, evening, or night.

The term “atmosphere” refers to a qualitative condition parameter in a prompt sentence describing the overall mood or ambience of a virtual city scene, such as calm, lively, safe, tense, bright, or dark.

The term “crowd density” refers to a parameter indicating the number or concentration of characters or agents in a virtual city space, affecting the perceived population and activity level.

The term “explanatory information” refers to information presented within or alongside a virtual city space that provides descriptive or educational content about structures, events, or historical context, and may be displayed, for example, via panels, overlays, or audio narration.

The term “event scene” refers to a temporally changing or animated situation within a virtual city space, such as a performance, gathering, festival, or other scenario that introduces dynamic elements and interactions.

The term “two-dimensional images from text” refers to images generated by a generative artificial intelligence model that receives text input and produces raster or vector image outputs representing scenes or objects described by the text.

The term “three-dimensional shapes from text” refers to geometric models or volumetric representations generated by a generative artificial intelligence model that receives text input and produces three-dimensional object or scene data consistent with the text description.

The term “three-dimensional reconstruction process” refers to processing that derives a three-dimensional representation of a scene or object from multiple two-dimensional images or views, using geometric or learned reconstruction algorithms.

The term “individual object meshes” refers to three-dimensional models representing discrete objects within a virtual city space, such as buildings, vehicles, trees, or characters, expressed as interconnected polygons or other geometric primitives.

The term “differential update data” refers to data representing changes or additions to an existing three-dimensional virtual city space, such that only modified or newly generated elements are transmitted to a terminal device instead of resending the entire scene.

In one embodiment, a server, a terminal, and a user cooperate to implement the claimed system. The server is implemented as a computing apparatus including at least one general-purpose processor (for example, a multi-core central processing unit), at least one graphics processing unit having a parallel computation architecture, a main memory, a non-volatile storage device, and a network interface. The server executes an operating system such as a general-purpose server operating system and runs an application framework that provides an HTTP server, a database interface, and a job scheduling mechanism. The terminal is implemented as an electronic device such as a mobile terminal, a tablet device, a head-mounted display device, or a personal computer, and includes a display device, a touch-sensitive input device, an imaging device, an audio input device, an inertial sensor unit, a positioning module, and a wireless communication module. The user operates the terminal to provide input information, supplies historical data, and experiences a three-dimensional virtual city space rendered by the terminal.

The server stores and executes a plurality of software modules. The server uses an image processing library such as a general-purpose computer vision library, a geographic information system library and spatial database extension, a deep learning framework such as a tensor-based neural network library, a three-dimensional modeling tool with script control such as a general-purpose three-dimensional modeling environment, and a three-dimensional reconstruction or neural rendering library. The server configures these software components as distinct modules including an input data management module, an image analysis module, a geographic data analysis module, an emotion analysis module, a prompt sentence generation module, a generative AI model inference module, an optimization module, and a streaming control module.

The terminal executes a client application that includes a graphical user interface module, a camera capture module, an audio capture module, an interaction logging module, and a three-dimensional rendering engine such as a game engine. The terminal uses a graphics processing pipeline to render three-dimensional meshes, textures, and lights supplied by the server and to display a three-dimensional virtual city space. The terminal also uses its inertial sensors to detect device orientation and uses this orientation to adjust the viewpoint in the virtual scene. The server treats “past image information” as digital raster images stored, for example, in compressed formats such as Joint Photographic Experts Group format. The server reads these files into memory and converts them into multi-dimensional arrays (for example, height×width×color channel tensors) for processing by a neural network. The server treats “geographic information” as structured data stored, for example, in vector formats such as geographic feature collections with coordinate reference systems. The server imports these data into a spatial database that stores geometric features in tables with spatial indices. By structuring data in this manner, the server can execute efficient spatial queries and join operations, which reduces computation time when constructing complex urban layouts.

The server implements the image analysis module using a convolutional neural network architecture. In one implementation, the server uses a multi-layer convolutional network with residual connections, batch normalization layers, and rectified linear unit activations to detect building regions in the past image information. The server applies a first convolutional network that outputs bounding boxes and class scores for objects such as structures, roads, and landmarks. The server then extracts each building region and passes it to a second convolutional network configured for regression and classification of building attributes. The second network outputs numerical values for estimated height, width, and aspect ratio, and categorical probabilities for roof types, façade styles, and window arrangement patterns. The server computes a cross-entropy loss for categorical outputs and a mean squared error loss for numerical outputs during training, and uses a gradient-based optimization algorithm such as stochastic gradient descent with momentum or an adaptive learning rate optimizer to update network weights. The server can apply data augmentation operations such as random cropping, flipping, and contrast adjustments during training to improve robustness against variations in historical images. By training on large corpora of labeled historical and modern building images, the server improves the accuracy of building shape information extraction compared to manual rule-based edge analysis.

The server implements the geographic data analysis module using a spatial database engine that supports geometric and topological operations. The server stores road polylines, building polygons, river centerlines, and elevation samples as geometry columns in relational tables.

The server builds R-tree or similar spatial indices to accelerate range queries and nearest-neighbor search. The server computes urban layout information by issuing structured queries that determine road connectivity, intersection nodes, block boundaries, and positional relationships between structures and open spaces. The server can apply graph algorithms on the road network, for example, computing shortest paths and centrality measures to identify major streets and plazas. The server may align historical coordinate systems with current coordinate systems using transformation parameters derived from control points. This structured and algorithmic processing of geographic information enables consistent reconstruction of urban layouts even when raw data originate from heterogeneous historical sources.

The server implements the emotion analysis module as a multimodal fusion system with distinct sub-networks. For facial image information, the server uses a convolutional neural network trained for facial expression recognition. The network comprises an input layer that accepts cropped and normalized face patches, multiple convolution and pooling layers that extract hierarchical features such as regions around the eyes and mouth, and fully connected layers that output a probability distribution over expression categories. The server trains this network using labeled datasets of facial expressions and uses a softmax output with cross-entropy loss. For audio information, the server uses an audio preprocessing pipeline that computes mel-frequency cepstral coefficients and energy-based features over time windows.

The server feeds these feature sequences into a recurrent neural network architecture such as a bidirectional long short-term memory network that models temporal dynamics. The server trains this network to output arousal and valence scores, using regression or classification losses depending on available labels.

For operation history information, the server aggregates events such as taps, swipes, viewpoint changes, and idle periods into fixed-length time windows, and computes features such as event counts, average swipe length, viewpoint change frequency, and dwell time at objects of interest. The server uses a separate neural network or gradient boosting model to map these feature vectors to scores representing interest and boredom. The server then concatenates the expression-derived scores, audio-derived scores, and behavior-derived scores into a feature vector and feeds this vector into an integration model, for example, a fully connected neural network with non-linear activations. The integration model outputs a multi-dimensional emotion state vector that includes at least pleasantness, arousal, interest, anxiety, and boredom. The server trains this integration model using supervised labels, such as self-reported emotion ratings or expert annotations, and a loss function that penalizes deviation from ground truth. Because the server uses learned multi-modal fusion rather than simple thresholding or averaging, the system reduces misclassification due to noise in any single modality and yields more stable emotion estimates, thereby improving downstream scene adaptation accuracy.

The server implements the prompt sentence generation module as a rule-augmented template engine. The server stores a set of template segments in a structured format, including segments for city description, temporal setting, atmosphere, crowd density, pedagogical information, and event scenes. The server also stores mapping rules that relate ranges of emotion state values and usage information categories to specific textual phrases or phrase families. For example, when the anxiety dimension exceeds a threshold, the server selects phrase segments that specify bright lighting, higher crowd density, and safe or open spaces; when boredom exceeds a threshold, the server selects phrase segments that introduce dynamic events such as performances or gatherings.

The server obtains building shape information and urban layout information from the analysis modules and encodes these in text form within the prompt sentence. For example, the server may generate phrases describing “narrow, tall structures with gabled roofs” or “wide avenues with intersecting cross streets” based on the extracted attributes and spatial relationships. The server then constructs a complete prompt sentence by concatenating and parameterizing these segments.

In one example, when the user selects an educational usage purpose and specifies a historical city, and when the emotion analysis module detects a high anxiety level, the server generates a prompt sentence such as:

“Using historical images and geographic data, generate a 3D reconstruction of 19th-century London for educational use. Place Big Ben and the surrounding road network at the center of the scene, and use Victorian brick buildings with narrow, tall façades and gabled roofs along the main streets. Because the user's anxiety level is high, set the scene in bright daytime, increase the number of pedestrians and streetlights, and create a safe and welcoming atmosphere. Add information panels near major buildings that explain important historical events in clear text.”

In another example, when the user requests a fictional future city and the emotion state vector indicates high interest and high arousal, the server generates a prompt sentence such as:

“Please construct a futuristic city that the user is strongly interested in. Generate a 3D city where sky gardens coexist with skyscrapers, and because the user's arousal level is high, set the scene at night with vivid neon lights. Add aerial walkways and floating vehicles to create a dynamic and lively atmosphere.”

These prompt sentences explicitly encode structured scene information and emotion-driven conditions, which allows the generative AI model to produce outputs that are not only visually rich but also aligned with the user's current emotional state and usage purpose. The prompt sentence generation module thus performs a non-trivial translation from multi-modal numerical state and structured spatial data into natural-language control signals for the generative AI model, improving the controllability and efficiency of generative inference compared to ad hoc, manually crafted prompts.

The server implements the generative AI model inference module using deep neural network architectures. In one embodiment, the server uses a diffusion-based text-to-image model that accepts a tokenized representation of the prompt sentence and generates multi-view images of the desired city environment. The server can fine-tune this model on urban imagery datasets to enhance its capability to render structures and street scenes. The server also uses a text-to-three-dimensional model, such as a neural implicit representation network or a voxel-based generator, to produce separate three-dimensional objects for buildings, streetlights, vegetation, and characters. The server conditions such models on specific textual tags derived from building shape information and urban layout information, ensuring that generated objects possess appropriate style, scale, and arrangement within the scene.

When the generative AI model produces only images, the server applies a three-dimensional reconstruction process. The server uses a neural rendering pipeline, such as a neural radiance field network, which takes as input the generated multi-view images and associated camera parameters and learns a volumetric representation of the scene. The server trains or adapts this model by optimizing a photometric loss between rendered views and input images, using gradient descent on neural network parameters. Once training converges, the server extracts a mesh representation using techniques such as marching cubes on an implicit surface representation. The server thus obtains a three-dimensional virtual city space that is consistent across viewpoints.

The server uses the three-dimensional modeling tool to integrate all generated meshes into a coherent scene. The server uses script interfaces to automatically assign materials, associate textures, and set up global illumination or approximate lighting models according to the time-of-day conditions specified in the prompt sentence. The server defines initial camera paths and observer positions and exports the composite scene into an interchange format such as a compact scene description that can be loaded by the terminal's three-dimensional engine.

The server then invokes the optimization module. The server applies a polygon count reduction algorithm, such as a quadric error metric simplification algorithm, to each mesh.

The algorithm iteratively collapses vertices and faces while controlling the approximation error below a configurable threshold. The server generates multiple levels of detail for each object, which are stored with metadata indicating distance-based or device-based selection thresholds. The server uses an image processing library to encode texture images into hardware-accelerated compression formats, and the server can downscale textures based on the target terminal's display resolution and memory constraints. By generating and selecting appropriate levels of detail and compressed textures, the server reduces the size of the three-dimensional virtual city space data and lowers the computational requirements for rendering.

The terminal receives the optimized three-dimensional virtual city space data through the network. The terminal loads meshes, materials, and textures into the three-dimensional rendering engine. The engine maintains a scene graph that represents hierarchical relationships among objects, such as buildings grouped by blocks or streets. The terminal configures the engine to use the provided levels of detail, selecting lower or higher detail renders depending on the camera distance and device performance metrics. The terminal uses a graphics application programming interface to submit rendering commands to the graphics processing unit, which transforms vertices, applies shading, and rasterizes the scene onto the display.

The terminal collects user input through the touch-sensitive device and motion sensors. When the user performs a swipe gesture, the terminal computes a change in camera orientation and updates the view matrix in the rendering engine. When the user performs a pinch gesture, the terminal adjusts the camera distance or field of view. When the user rotates the device, the terminal reads orientation data from the inertial sensors and applies corresponding rotations to the camera. When the user taps on a visible object, the terminal casts a ray from the screen coordinate into the three-dimensional scene to identify the intersected object and sends an object identifier to the server to request associated explanatory information. The terminal then displays textual or graphical descriptions in an overlay.

During the user's experience, the terminal continues to capture facial image information, audio information, and operation history information and to transmit such data to the server at defined intervals. The server repeatedly executes emotion analysis using the updated data, updates the emotion state vector, and determines whether to modify the current scene. When the server detects increasing boredom, the server constructs a new prompt sentence that refers to the existing scene and instructs the generative AI model to generate additional event scenes. For example, the server may generate a prompt sentence such as:

“Because the user is feeling bored, please add a scene in the current 19th-century London street where a street performer starts a show. Create a small crowd, with elements that convey music and applause, to make the scene more engaging.”

The server then uses the generative AI model to generate new meshes and animations for a performer, a group of spectators, and any additional props. The server optimizes these assets and transmits them as differential update data to the terminal. The terminal integrates these assets into the existing scene at runtime, instantiates new objects, and starts appropriate animations, thus changing the scene without reloading the entire world. When the server detects rising anxiety, the server similarly updates the lighting parameters and crowd distribution via additional prompt sentences and differential updates.

This design yields specific technical effects. By using multi-modal emotion analysis and structured building and layout information to drive prompt sentence generation, the server reduces the number of generative AI model inferences that produce irrelevant or unused content and focuses processing on content that matches current user state. The integration of levels-of-detail and adaptive texture compression with incremental scene updates reduces network traffic and rendering load on the terminal, enabling higher frame rates and lower latency on resource-constrained devices. The use of structured data representations, spatial indexing, and neural network architectures tailored to buildings, audio features, and behavior signals improves the precision and robustness of scene generation compared to simpler rule-based approaches. Because the server continually closes the loop between emotion analysis, prompt generation, generative inference, and optimization, the system provides a technically improved control mechanism for the generative AI model and the three-dimensional rendering process, beyond mere automation of human design tasks.

Variations of these embodiments are possible. The server may use alternative neural architectures for expression recognition, such as vision transformers, or alternative generative architectures, such as auto-regressive image generators or diffusion models conditioned on layout maps. The server may execute emotion analysis partially on the terminal to reduce network latency, with the terminal computing local features and the server performing fusion.

The terminal may use different three-dimensional engines, such as engines optimized for head-mounted displays with support for stereoscopic rendering and low-latency head tracking.

The system may also adapt other environment parameters, such as soundscapes and particle effects, based on emotion states by generating additional audio cues or environmental visual components through the generative AI model and streaming them as differential updates.

In all of these embodiments, the server, the terminal, and the user interact in a coordinated fashion, and the processor in the server performs concrete data transformations on structured image, geographic, emotion-related, and three-dimensional scene data. The system thereby improves the functioning of the computing environment by increasing generation accuracy, reducing bandwidth usage, and stabilizing frame rates while dynamically adapting the virtual city according to the user's emotional state.

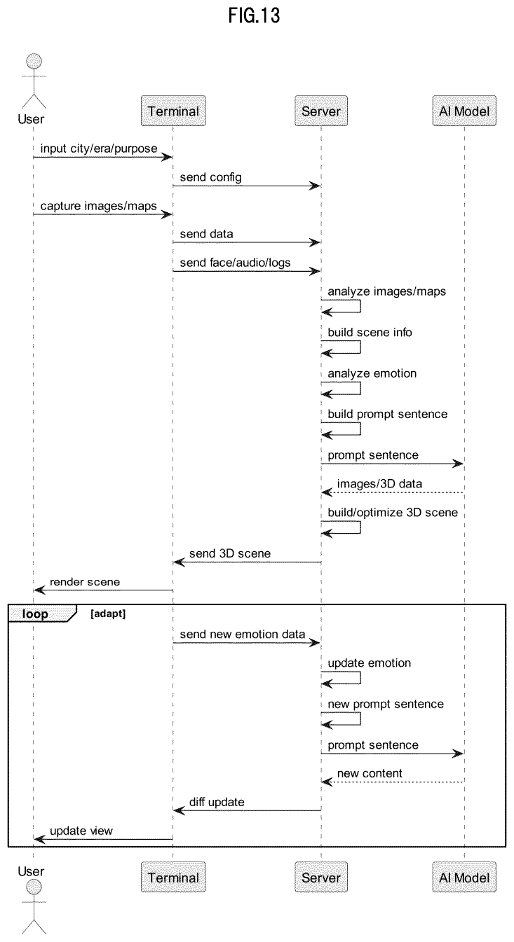

The following describes the processing flow using FIG. 13.

Step 1: User operates the terminal to specify initial conditions.

User touches input fields on the terminal display and enters a target city name, a time period, and usage information such as education, sightseeing, or entertainment. User may alternatively press a microphone icon and speak this information.

Terminal receives these inputs as text strings (from a keyboard or speech recognizer) as input data, parses them, and stores them in an internal data structure, for example a key-value map with keys “city,” “era,” and “purpose.” Terminal performs data validation as a data processing operation, checking for missing fields and invalid formats, and then generates a structured request object as output. Terminal transmits this structured request to the server via a network interface as an HTTP or similar message.

### Step 2:

User provides past image information and geographic information.

User activates a capture function on the terminal and uses the terminal camera to take pictures of historical photographs or maps. User may also select pre-existing geographic files, such as vector map files, from the terminal's storage, or choose an option to use the current location.

Terminal receives raw camera frames and geographic file pointers as input data. Terminal performs image processing operations such as resizing and compression to convert raw frames into compressed images, and it performs file I/O operations to read geographic files and, if necessary, compress them. Terminal outputs compressed image files and geographic files, then attaches them to the structured request. If the user chooses the current location option, terminal reads latitude and longitude from a positioning module as input, and outputs coordinate values. Terminal transmits the compressed images, geographic files, and coordinate values to the server over the network.

### Step 3:

Terminal starts continuous acquisition of emotion-related information.

Terminal activates the front camera and continuously captures facial frames as input, and applies a face detection algorithm to crop facial regions. Terminal resizes and compresses these crops as data processing operations and outputs face thumbnails. Terminal also opens an audio capture stream, samples microphone input as digital audio, and segments it into fixed-length chunks as data processing operations, outputting digital audio segments. Terminal further registers event listeners in the client application and records user interaction events (taps, swipes, viewpoint changes) with timestamps and coordinates as input, then aggregates these into operation history records as output. Terminal periodically transmits batched face thumbnails, audio segments, and operation history records to the server.

### Step 4:

Server receives and stores initial request data and prepares analysis.

Server accepts the city, era, usage information, past image information, geographic information, and coordinate values from the terminal as input via a network interface. Server parses the incoming message using an application framework and normalizes text values and data formats as data processing operations. Server stores normalized inputs in persistent storage tables as structured records, for example a table for user sessions and separate tables for images and geographic files. Server outputs database identifiers associated with the stored data, which subsequent modules use as references.

### Step 5:

Server executes image analysis to construct building shape information.

Server loads the past image information from storage into memory as image arrays as input.

Server applies pre-processing operations, including grayscale conversion, noise reduction, and contrast normalization. Server passes the processed images to an object detection neural network as input; the network performs convolution, pooling, and activation operations as data computations to output bounding boxes and class probabilities for detected structures and roads. Server extracts image patches for each detected structure and feeds them to a second neural network trained for attribute estimation. This second network performs further convolution and fully connected layer computations to output numerical attributes, such as estimated height and width, and categorical attributes, such as roof type and façade style.

Server aggregates these attributes as building shape information and writes them into structured fields in a database as output.

### Step 6:

Server executes geographic analysis to construct urban layout information.

Server imports geographic information files and coordinate values into a spatial database as input. Server converts geometric features into internal representations (polylines, polygons, and points) and builds spatial indices as data processing operations. Server issues spatial queries to compute road connectivity, intersections, building groupings, and relationships between structures and open areas. Server may apply coordinate transformations as data computations to align historical datasets with a common coordinate system. Server then aggregates these results as urban layout information, represented, for example, by tables linking segments, nodes, and zones. Server stores the urban layout information as database records and outputs queryable identifiers for later use.

### Step 7:

Server analyzes emotion-related information to obtain an emotion state vector.

Server receives face thumbnails, audio segments, and operation history records from the terminal as input. For face thumbnails, server decodes the images into tensors and feeds them to a facial expression recognition network, which performs convolutional and pooling operations to output probabilities for expression categories. Server converts these probabilities into numerical scores as data processing operations. For audio segments, server computes acoustic features such as mel-frequency coefficients and energy metrics, then inputs these features into an audio emotion recognition network that applies recurrent or attention-based operations to output arousal and valence scores. For operation history records, server computes interaction features, such as event frequency and dwell time, and applies a behavioral analysis model that performs weighted summation or neural computation to output interest and boredom scores. Server concatenates expression-based, audio-based, and behavior-based scores and passes this combined vector to a fusion network as input. The fusion network performs multilayer computations to output an emotion state vector with dimensions such as pleasantness, arousal, interest, anxiety, and boredom. Server writes this emotion state vector to a session state store as output.

### Step 8:

Server generates a prompt sentence based on structured scene information and the emotion state.

Server retrieves building shape information, urban layout information, usage information, and the current emotion state vector as input. Server selects appropriate template fragments and parameter values as data processing operations: for example, server selects a “daytime and safe” fragment when anxiety is high, or an “event introduction” fragment when boredom is high. Server also converts building shapes and urban layouts into descriptive text segments by mapping structural and topological attributes to phrases describing style and arrangement.

Server assembles these segments into a coherent prompt sentence by concatenation and placeholder substitution as data processing. Server outputs the generated prompt sentence as a text string, such as:

“Using historical images and geographic data, generate a 3D reconstruction of 19th-century London for educational use. Place Big Ben and the surrounding road network at the center of the scene, and use Victorian brick buildings with narrow, tall façades and gabled roofs along the main streets. Because the user's anxiety level is high, set the scene in bright daytime, increase the number of pedestrians and streetlights, and create a safe and welcoming atmosphere. Add information panels near major buildings that explain important historical events in clear text.”

### Step 9:

Server invokes the generative AI model to produce scene content.

Server tokenizes the prompt sentence into a sequence of tokens as input and feeds this sequence to a generative AI model, such as a diffusion-based text-to-image network or a text-to-3D generator. The generative AI model executes internal linear transformations, attention mechanisms, and sampling procedures as data computations, conditioned on the tokenized prompt, to output either multi-view images of the target city or direct three-dimensional object representations. When the model outputs images, server passes these images and corresponding camera parameters to a three-dimensional reconstruction process that performs volumetric fitting, ray sampling, and optimization of a neural radiance representation as data computations, then extracts a polygon mesh as output. When the model outputs individual three-dimensional shapes, server parses them into mesh structures as output and aligns them to coordinates specified by the urban layout information.

### Step 10:

Server builds a unified three-dimensional virtual city space and optimizes it.

Server aggregates meshes, textures, and lights from the generative AI model and reconstruction processes as input. Server uses a three-dimensional modeling tool's script interface to assign materials, bind textures, and configure light sources as data processing actions. Server exports a consolidated three-dimensional scene description containing mesh data and material parameters. Server then invokes a mesh simplification algorithm, which iteratively collapses vertices and edges while computing and bounding geometric error metrics as data computations. Server generates multiple levels of detail for each mesh and compresses textures into hardware-accelerated formats. Server outputs optimized three-dimensional virtual city space data, packaged with metadata describing levels of detail and resource requirements. Server transmits this optimized data to the terminal as a data stream.

### Step 11:

Terminal loads and renders the three-dimensional virtual city space.

Terminal receives the optimized three-dimensional virtual city space data as input and loads meshes, materials, textures, and lighting into a three-dimensional rendering engine. Terminal constructs a scene graph as a data structure, linking objects in a hierarchical manner. Terminal submits rendering commands to its graphics hardware, which performs vertex transformations, shading, and rasterization as computations. Terminal outputs rendered frames to the display, showing the three-dimensional virtual city space. Terminal also receives user interaction events and motion sensor readings as input and updates the virtual camera position and orientation accordingly. Terminal performs these camera updates as geometric calculations and outputs updated views on each frame, enabling the user to navigate the scene.

### Step 12:

Server performs continuous emotion-driven adaptation and sends differential updates.

Server continues to receive updated face thumbnails, audio segments, and operation history records from the terminal as input. Server repeats emotion analysis, updating the emotion state vector as new output. Server monitors changes in this vector and, when specific thresholds are crossed, generates additional prompt sentences that refer to the current scene and specify modifications, such as adding an event scene or altering lighting. Server feeds these new prompt sentences to the generative AI model as input and performs localized content generation, producing new meshes, animations, or modified lighting parameters as output. Server runs optimization on these new assets to produce compressed and level-of-detail-managed representations, then computes differences between the current scene and the new content as data processing operations. Server outputs differential update data and transmits these updates to the terminal, enabling the three-dimensional virtual city space to change in real time in response to the user's evolving emotional state.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional virtual urban simulation systems generally focus on ingesting historical images and geographic information, extracting objective features such as building geometry or road networks, and generating a three-dimensional virtual environment that can be rendered on a client device. While such systems may employ geographic information processing and three-dimensional modeling, they typically treat the user merely as a passive viewer and do not adapt the simulation content or presentation to the user's subjective state. As a result, these systems suffer from several technical limitations.

First, conventional systems do not utilize fine-grained emotional feedback from the user as a control signal within the data processing pipeline. Existing virtual reality and geographic information systems generally generate a single, static visualization or a small set of preconfigured scenarios based solely on past spatial data and predefined parameters. They lack a mechanism for continuously sensing facial information, voice information, and motion information on a terminal, estimating a multi-dimensional emotion state in real time, and feeding that state back into upstream components of the data pipeline. Consequently, the generated virtual environments are not dynamically adjusted to the user's level of understanding, interest, or cognitive load, which leads to inefficient use of computational and network resources, as many frames or scenarios are rendered that the user finds confusing, tedious, or overwhelming.

Second, known systems do not exploit generative AI models in a structured, programmatic way as an internal transformation stage driven by both objective urban indicators and user emotion states. In most systems, if generative models are used at all, they are invoked through static, hand-crafted descriptions, and the output is treated as a one-off design artifact. There is no systematic generation of prompt sentences that encode computed feature values, future prediction indicators, and emotion-dependent constraints, nor is there a mechanism for iteratively refining prompt sentences as a function of measured user reactions. This results in a rigid architecture where the generative model is not tightly integrated with the analytics and rendering stack, and where the system cannot automatically converge toward more suitable future urban layouts based on feedback.

Third, conventional server-client architectures for virtual city visualization do not coordinate data analysis, content generation, and rendering optimization in a unified, emotion-aware control loop. Server-side components typically perform heavy geographic and modeling computations in a batch style, and client-side components render whatever is delivered, applying only generic level-of-detail techniques. There is no processor-level logic that, on the server, transforms raw spatial and statistical data into normalized feature tensors, predicts future layers, constructs prompt sentences for a generative AI model, generates structured urban layout data, and then selectively optimizes and delivers only those portions of the virtual space that are likely to be useful and comfortable for the user given the user's current emotion state. Without such a feedback-driven loop, network bandwidth, GPU cycles, and CPU cycles are not used efficiently, and user navigation often leads to suboptimal frame rates or unnecessary detail in regions the user does not need.

Accordingly, there is a need for an improved computer-implemented system and method in which a processor: (i) normalizes and analyzes spatial and statistical data to compute urban structure indicators and future prediction indicators; (ii) uses these indicators to automatically generate prompt sentences for a generative AI model; (iii) generates and optimizes virtual space data representing future urban layouts; and (iv) simultaneously estimates a multi-dimensional emotion state from user sensor data on a terminal and dynamically controls both the prompt sentences and presentation parameters based on the emotion state. Such a system would improve the functioning of the underlying computing environment by reducing unnecessary data transmission and rendering, by tailoring generative AI outputs to user-specific conditions in real time, and by enabling iterative, emotion-aware refinement of complex three-dimensional virtual environments.

The specific processing by the specific processing unit 290 of the data processing device 12 in Application Example 2 is realized by the following means.

The present invention provides a server comprising a processor configured to acquire past spatial data and current spatial data from a communication line or a storage device, normalize the spatial data based on coordinate reference information and time information, and store the normalized spatial data with associated metadata in a storage structure; analyze the stored spatial data and statistical data by executing image processing, time-series processing, and spatial processing to calculate feature values including urban structure indicators and future prediction indicators; generate, on the basis of the calculated feature values and future time conditions, a prompt sentence that describes a generation target and generation conditions for a generative AI model, input the prompt sentence into the generative AI model, and thereby generate urban layout data representing an urban structure; convert the urban layout data into virtual space data by performing three-dimensional modeling processing, and perform load-reduction processing including polygon simplification, data partitioning, and level-of-detail setting on the virtual space data so as to optimize the virtual space data for a terminal device; obtain at least one of facial information, voice information, and motion information of a user from the terminal device, execute emotion estimation processing on the obtained information to calculate an emotion state including at least a pleasure-displeasure index, an arousal index, and an engagement index; dynamically change, in accordance with the calculated emotion state, at least one of a content of the prompt sentence to be input to the generative AI model and a presentation mode of the virtual space data and control operations of the generation of the urban layout data and the optimization of the virtual space data based on the changed content or presentation mode; and provide optimized virtual space data and interaction control information to the terminal device so that a user interface on the terminal device performs three-dimensional display and accepts user operations including viewpoint movement, selection operation, and voice input. This enables an integrated, emotion-aware data processing pipeline in which server-side computation, generative AI-driven content synthesis, and client-side rendering are adaptively controlled based on real-time emotion states, thereby improving overall computer system performance in terms of processing efficiency, bandwidth utilization, and user-perceived responsiveness when generating and presenting complex three-dimensional virtual urban environments.

The term “spatial data” refers to digital data that represents locations and shapes of objects or regions in a coordinate space, including but not limited to raster data, vector data, and associated attributes tied to geographic or geometric coordinates.

The term “past spatial data” refers to spatial data acquired for one or more time points or periods in the past, such as historical geographic information, historical imagery, and archived map layers representing previously existing urban structures and environments.

The term “current spatial data” refers to spatial data acquired for a present or recent time point, including up-to-date geographic information, imagery, and map layers representing a current urban structure and environment.

The term “coordinate reference information” refers to information that defines how spatial data is located in a geometric or geographic space, including coordinate reference systems, map projections, and related transformation parameters.

The term “time information” refers to information indicating temporal aspects associated with data, including acquisition time, observation period, target year, and any other temporal metadata used for time-series alignment or prediction.

The term “storage structure” refers to one or more logical or physical arrangements for storing data in a computing environment, including file systems, databases, object storage services, and memory-resident data structures.

The term “metadata” refers to descriptive information about data, including identifiers, city names, coordinate reference systems, time ranges, data types, acquisition conditions, and processing status.

The term “statistical data” refers to data representing quantitative measurements or aggregated values, including but not limited to population statistics, traffic counts, environmental indicators, and other numerical data associated with spatial regions or time periods.

The term “image processing” refers to computational operations applied to image data, including filtering, segmentation, feature extraction, classification, and other transformations used to derive structured information from images.

The term “time-series processing” refers to computational operations applied to data indexed by time, including temporal aggregation, forecasting, smoothing, and modeling using time-series algorithms or machine learning models.

The term “spatial processing” refers to computational operations that exploit spatial relationships in data, including coordinate transformation, spatial aggregation, proximity analysis, and spatial statistics.

The term “feature values” refers to numerical or categorical values derived from raw data by analysis or transformation, which capture properties or characteristics of an urban environment, user state, or other entities for use in subsequent computation.

The term “urban structure indicators” refers to feature values that describe structural aspects of an urban environment, including but not limited to building density, road length, intersection density, green area ratio, and land-use composition.

The term “future prediction indicators” refers to feature values that represent predicted or forecasted quantities for one or more future time points, including predicted population distribution, predicted traffic demand, and predicted environmental load indicators.

The term “future time conditions” refers to conditions specifying one or more target future times or periods, including target years, time horizons, or scenarios used for generating future urban layouts and predictions.

The term “prompt sentence” refers to a sequence of symbols including natural language text, structured text, or a combination thereof, which specifies a generation target, generation conditions, constraints, and explanatory requirements as input for a generative AI model.

The term “generation target” refers to content that is requested to be generated by a generative AI model, including but not limited to urban layout configurations, facility arrangements, descriptive explanations, and scenario alternatives.

The term “generation conditions” refers to constraints or requirements imposed on a generative AI model, including numerical targets, qualitative preferences, emotion-dependent modifiers, and references to analysis results or baseline layouts.

The term “generative AI model” refers to an artificial intelligence model configured to generate new data or content based on input information, including but not limited to neural network-based generative models that accept prompt sentences or structured data and output urban layouts, structural descriptions, or explanatory text.

The term “urban layout data” refers to structured data that represents a configuration of an urban environment, including blocks, roads, facilities, land-use categories, and their spatial relationships, suitable for conversion into virtual space data.

The term “virtual space data” refers to data describing a three-dimensional virtual environment, including geometric meshes, textures, material attributes, lighting parameters, and scene graph structures that can be rendered by a graphics engine.

The term “three-dimensional modeling processing” refers to computational operations that construct or modify three-dimensional representations of objects or environments, including placement of template models, geometry generation, transformation, and scene composition.

The term “load-reduction processing” refers to computational operations that reduce computational, memory, or bandwidth cost while maintaining acceptable quality, including polygon simplification, data partitioning, and level-of-detail control.

The term “polygon simplification” refers to a process of reducing the number of geometric primitives such as vertices, edges, and faces in a three-dimensional mesh while preserving overall shape or appearance within a tolerance.

The term “data partitioning” refers to dividing data into multiple segments or units, such as tiles, zones, or chunks, in order to facilitate selective loading, streaming, or processing.

The term “level-of-detail setting” refers to defining and managing multiple representations of the same object or region at different degrees of geometric or visual detail, and selecting an appropriate representation according to viewing conditions or resource constraints.

The term “terminal device” refers to any user-side computing device configured to receive virtual space data and interaction control information, including but not limited to head-mounted displays, mobile devices, desktop computers, or integrated VR/AR systems.

The term “facial information” refers to image data or features related to a user's face, including facial images, facial landmarks, and derived facial expressions used for emotion estimation.

The term “voice information” refers to audio data or features derived from a user's speech or vocal sounds, including raw audio waveforms, acoustic feature vectors, and voice activity indicators used for emotion estimation.

The term “motion information” refers to data representing movement or posture of a user or a user-operated device, including position, orientation, acceleration, and interaction events obtained from sensors such as inertial measurement units or controllers.

The term “emotion estimation processing” refers to computational operations that infer an internal psychological or affective state of a user based on input information such as facial information, voice information, and motion information, typically using pattern recognition or machine learning techniques.

The term “emotion state” refers to information representing a user's estimated psychological or affective condition, including at least a pleasure-displeasure index, an arousal index, and an engagement index, and optionally additional affective parameters.

The term “pleasure-displeasure index” refers to a scalar or vector value representing a degree of positive or negative valence of a user's emotion state along an axis from pleasant to unpleasant.

The term “arousal index” refers to a scalar or vector value representing a level of activation or alertness of a user's emotion state, including states such as calm, neutral, or excited.

The term “engagement index” refers to a scalar or vector value representing a degree of attention, interest, or involvement of a user in a presented virtual environment or task.

The term “presentation mode” refers to a configuration of how virtual space data is displayed and interacted with on a terminal device, including selection of viewpoints, visible objects, overlay information, navigation schemes, and visual emphasis.

The term “user interface” refers to one or more software and hardware components that mediate interaction between a user and a system, including graphical elements, control elements, input handling logic, and output rendering functions.

The term “viewpoint movement” refers to changes in the virtual camera position or orientation within a virtual space in response to user actions or system control.

The term “selection operation” refers to a user action that identifies or activates a particular object, region, or control element within a user interface or virtual space.

The term “voice input” refers to user-provided audio signals containing spoken commands or expressions, which are captured by input devices and processed by recognition or interpretation algorithms.

The term “interaction responses” refers to system outputs generated in reaction to user operations, including visual changes, navigation updates, informational overlays, and modifications to the virtual environment.

In the following embodiments, a server, a terminal, and a user are described as main actors. The embodiments are illustrative and may be modified by a person skilled in the art without departing from the scope of the claims.

Server constitutes a general-purpose information processing apparatus that includes a central processing unit (CPU), a main memory, a nonvolatile storage device, a graphics processing unit (GPU), and a network interface. Server executes an operating system for server use and one or more application programs written in a scripting language and a compiled language.

Server uses a machine learning library capable of constructing, training, and performing inference of neural networks (for example, a library equivalent to PyTorch or TensorFlow), a geographic information processing library capable of processing raster data and vector data (for example, a library equivalent to GDAL or a spatial database extension), and a three-dimensional modeling engine that can be controlled by scripts (for example, an engine equivalent to a script-controllable three-dimensional modeling tool or a game engine server build).

Terminal constitutes an information processing apparatus including a CPU, a GPU, a display device or a head-mounted display, an imaging device, an audio acquisition device, an inertial sensor, one or more position/orientation tracking sensors, and a communication interface.

Terminal executes an operating system for mobile or general-purpose use and a run-time environment for virtual reality or augmented reality display (for example, a run-time equivalent to a game engine run-time). Terminal uses an inference run-time capable of executing trained neural network models (for example, an engine equivalent to ONNX Runtime) for emotion estimation.

User wears or views terminal and visually experiences a three-dimensional virtual environment representing a future urban structure. User operates the virtual environment using controllers, hand tracking, gaze, and voice input.

Server receives past spatial data and current spatial data via the network interface. Server receives, for example, geographic information system (GIS) data in a vector format, raster image data including satellite images and aerial photographs, and statistical data including population statistics, traffic counts, and climate time series. Server parses file headers and metadata to identify coordinate reference systems and data types, and server stores the raw data in a file system or object storage while storing metadata such as city name, time period, data source, and coordinate reference system in a database.

Server uses the geographic information processing library to normalize spatial data. Server reprojects raster images to a standard coordinate reference system and resamples them to a unified spatial resolution. Server reprojects vector layers such as roads, buildings, green areas, and water bodies to the same coordinate system and clips them to a defined urban region.

Server reads statistical data using a data processing library and aggregates values per year and per spatial mesh unit. Server thereby generates normalized data tables in which each record is keyed by a mesh identifier and a time index and includes values such as building area, road length, population count, and average temperature.

Server performs image analysis on satellite and aerial images to extract semantic classes of urban objects. Server uses the machine learning library to execute an image segmentation neural network implemented as an encoder-decoder architecture (for example, a convolutional encoder with down-sampling stages and a symmetric decoder with up-sampling and skip connections, similar to a U-Net architecture). Server stores network weights in the nonvolatile storage device and loads them into GPU memory during inference. Server inputs batches of normalized image tiles to the network and obtains, for each pixel, class probabilities for classes such as building, road, green area, water, and background. Server assigns each pixel the class with the maximum probability and generates a label map.

Server applies connected component analysis to each class region to obtain contiguous regions. Server converts each contiguous building region to a polygon and each contiguous road region to a polyline by using vectorization algorithms, and server inserts these polygons and polylines into a spatial database. Server aggregates geometric features by mesh unit, calculating building footprint area, building count, total road length, intersection count, and green area ratio. These values constitute urban structure indicators.

Server builds a time-series prediction model suitable for spatiotemporal data. Server forms input tensors in which time steps are arranged along a temporal dimension and mesh units are arranged along a spatial dimension, and feature channels correspond to urban structure indicators and historical statistical values. Server implements, for example, a recurrent neural network with long short-term memory (LSTM) units or a temporal convolutional network with dilated convolutions. Server defines a loss function such as mean squared error between predicted and actual values for training data and uses stochastic gradient descent or a variant thereof to update weights. Server may augment training data by adding noise to inputs, shifting time windows, or perturbing spatial meshes to improve generalization.

Server trains the time-series model using historical data and then fixes the trained weights for inference. Server inputs current and historical features and obtains, for each mesh, predicted values at future time points: predicted population density, predicted traffic demand, and predicted environmental impact indices. Server writes these future prediction indicators into new spatial layers, each layer being a matrix indexed by mesh and time.

Server generates prompt sentences for a generative AI model based on the analysis results.

Server summarizes key indicators, such as areas of anticipated congestion, high-density residential zones, and areas of climate vulnerability, and inserts them into a prompt template along with target years and scenario types. Server expresses the template in natural language or structured text, for example:

“You are an urban planning generative AI model for designing a smart city in the year 2050. Based on the following predicted population density map, traffic demand hotspots, and climate risk zones, generate three alternative urban layout plans that significantly differ from the current road network. Each plan shall include elevated autonomous-vehicle corridors, multi-level intersections at major bottlenecks, distributed renewable energy facilities, and large green corridors that mitigate heat island effects.”

Server can also generate a more conservative prompt sentence, such as:

“You are an assistant generative AI model for explaining a future city in the year 2035. Based on the predicted traffic bottlenecks and population distribution, generate one future urban layout plan that keeps changes minimal and is easy to understand. The plan shall include a small number of new bypass roads, limited bus-only lanes, and expanded green belts. For each change, add a short explanation of how it reduces congestion or improves residential comfort.”

Server passes the generated prompt sentence and any structured context (for example, lists of mesh values and constraints) to the generative AI model. The generative AI model may be implemented as a large-scale transformer-based language model parameterized by a large number of weights. Server tokenizes the prompt sentence, applies embedding layers, and sends the token sequence to the generative AI model running on a dedicated inference engine in the server environment or on a connected computation service. The model generates output tokens that represent urban layout descriptions in a structured text format, such as a list of blocks with coordinates, building types, and road connectivity.

Server parses the generated output using a parser module. Server identifies block identifiers, spatial coordinates (for example, mesh-based x-y indices), land-use categories, road segments, and facility definitions. Server converts the structured output into urban layout data, which comprises tables of blocks, roads, and facilities, each having attributes and coordinates.

Server converts urban layout data into virtual space data using the three-dimensional modeling engine. Server maps each block type to a three-dimensional template model, such as a generic high-rise building, medium-rise residential block, public facility, or park model.

Server computes world coordinates by transforming mesh indices into local 3D coordinates, applying scale and height functions derived from predicted population density or land use.

Server places road meshes along polylines and extrudes building footprints into volumes based on specified heights. Server configures lighting, atmospheric effects, and environment settings such as sky color and ambient occlusion.

Server then performs load-reduction processing to optimize virtual space data. Server uses mesh simplification algorithms, for example based on quadratic error metrics, to reduce polygon counts while preserving visually important edges and silhouettes. Server partitions the overall city mesh into spatial tiles, each tile covering a subset of the city, and for each tile generates multiple levels of detail by further simplification for distant views. Server compresses textures using GPU-friendly compressed formats and encodes mesh data with geometry compression schemes. Server stores tile data bundles and associated metadata (tile identifiers, level-of-detail levels, bounding volumes) in storage accessible to terminal via the network.

Terminal receives information about available tiles and levels of detail from server. Terminal requests the necessary tile bundles based on user position and view direction. Terminal uses a decompression library to restore meshes and textures, and loads them into the VR/AR run-time's scene graph. Terminal tracks head pose using the inertial sensor and any external tracking system, updates a virtual camera transform, and renders frames at the refresh rate.

Terminal displays the future urban environment stereoscopically when a head-mounted display is used.

Terminal acquires facial information, voice information, and motion information while user experiences the virtual environment. Terminal uses the imaging device to capture frames that include user's face, runs a face detection algorithm, crops and normalizes face regions, and feeds them into an emotion recognition neural network. The network may be structured as a convolutional neural network followed by fully connected layers that output probabilities for emotion categories such as joy, boredom, confusion, and stress. Terminal uses the inference run-time to execute this network efficiently on embedded hardware.

Terminal also records audio from the audio acquisition device and computes acoustic features such as Mel-frequency cepstral coefficients over sliding windows. Terminal inputs these feature vectors to a speech emotion recognition model, which may be implemented as a recurrent neural network or a temporal convolutional network. The model produces probabilities for vocal emotion categories.

Terminal fuses facial and vocal emotion probabilities, for example by a small fully connected neural network or by rule-based weighted averaging, to compute continuous emotion indices: a pleasure-displeasure index, an arousal index, and an engagement index. Terminal smooths these indices over time through low-pass filtering or moving averages to reduce noise.

Terminal constructs an emotion state object that includes these indices and timestamps and periodically transmits the object to server.

Server receives emotion state information and uses threshold rules or a simple classifier to assign labels such as “bored state,” “stressed state,” or “high-engagement state.” Server stores the emotion label along with session identifiers. Server then modifies subsequent prompt sentences in accordance with the emotion state. When server detects a bored state, server inserts constraints into prompt sentences that request visually dynamic and structurally diverse urban layouts, for example:

“The user is bored. Increase the degree of structural change from the current city, add more elevated transportation structures, and introduce visually striking landmark buildings and extensive sky gardens.”

When server detects a stressed state, server adds conditions that emphasize similarity to the current city and clarity of explanation, for example:

“The user feels stressed and confused. Generate a future layout that differs only moderately from the current structure. Highlight only the most important changes and provide short, simple explanations for each change.”

By recalculating prompt sentences based on emotion states and feeding them into the generative AI model, server causes the generative AI model to produce urban layout data that better matches user's cognitive and emotional conditions. This feedback structure is not a mere automation of human decision making; it dynamically reshapes the sequence of computations in server, proactively changes data generation, and reduces the generation and transfer of layouts that user is unlikely to understand or tolerate.

Terminal further adjusts presentation parameters based on emotion state. Terminal reduces overlay information, hides nonessential panels, and slows down camera movement when user is in a stressed state to lower cognitive load and motion discomfort. Terminal increases detail panels, highlights analytic overlays, and dynamically pops up explanatory texts when user is highly engaged. Terminal thereby optimizes use of GPU and display resources by aligning level of detail and information density with user state, which improves rendering stability and reduces unnecessary redraws.

User can utter voice commands such as “Show me a plan with much less congestion” or “Make this neighborhood more suitable for families with children.” Terminal uses a speech recognition engine to convert spoken input into text and sends the text along with current view context to server. Server uses natural language processing algorithms, implemented for example via a smaller language model or rule-based parser, to extract intents and quantitative constraints from the text (e.g., “reduce congestion by 50%,” “increase childcare facilities within walking distance”). Server incorporates these constraints into the next prompt sentence, combining them with future prediction indicators and emotion state. For example, server may generate:

“You are a generative AI model for urban plan refinement in the year 2050. The user strongly requests further congestion reduction and a family-friendly environment. Using the current layout as a baseline and the predicted traffic and population layers, generate two alternative layouts that reduce peak congestion by at least 50% and ensure that childcare centers, elementary schools, and parks are located within a 10-minute walk of residential areas. Output a structured list of blocks, road changes, and facility placements.”

Server again passes this prompt sentence to the generative AI model, obtains updated urban layout data, and reconstructs optimized virtual space data. Terminal receives updated tile bundles and smoothly transitions the displayed scene to the new urban layout using interpolation of camera and scene parameters.

This configuration of server and terminal achieves technical effects beyond abstract data manipulation. Server reduces computation and bandwidth by adaptively generating and transmitting only those 3D assets that correspond to emotion-appropriate scenarios and tile regions currently in view. Server distributes heavy processing across distinct modules: geographic normalization, feature extraction, time-series prediction, generative AI invocation, and 3D optimization. Each module uses specialized algorithms and data structures that are not conventional combinations: the integration of multi-dimensional emotion indices into prompt sentence generation and level-of-detail control results in a non-trivial modification of processing order and resource allocation in the computing environment.

Because server normalizes spatial data into mesh-based feature tables and uses time-series neural networks with explicit loss functions and weight updates, server improves prediction accuracy of future indicators compared to simple heuristic models. Because server uses emotion-guided prompt sentences and generative AI models to synthesize layouts, server can search a high-dimensional design space more efficiently than manual human design, while the emotion loop prevents repeated generation of unhelpful scenarios. Overall, the system improves processing efficiency, reduces wasted network traffic, and improves responsiveness as perceived by user when interacting with complex three-dimensional virtual urban environments.

In alternative embodiments, server may implement different neural network architectures for segmentation, such as fully convolutional networks or vision transformer-based models, or different generative AI architectures, such as graph-based generative models for road networks. Server may execute training steps offline and only perform inference online, or may adapt weights in a limited way using user feedback as additional training signals. Terminal may be implemented as a standalone head-mounted device, a tablet computer, or a desktop computer with a separate head-mounted display. The overall control flow remains that server ingests and analyzes spatial and statistical data, derives urban structure and future indicators, generates emotion-aware prompt sentences, obtains urban layout data from a generative AI model, optimizes 3D virtual space data, and delivers it to terminal, while terminal senses user emotion, displays the virtual environment, and adapts presentation to user state.

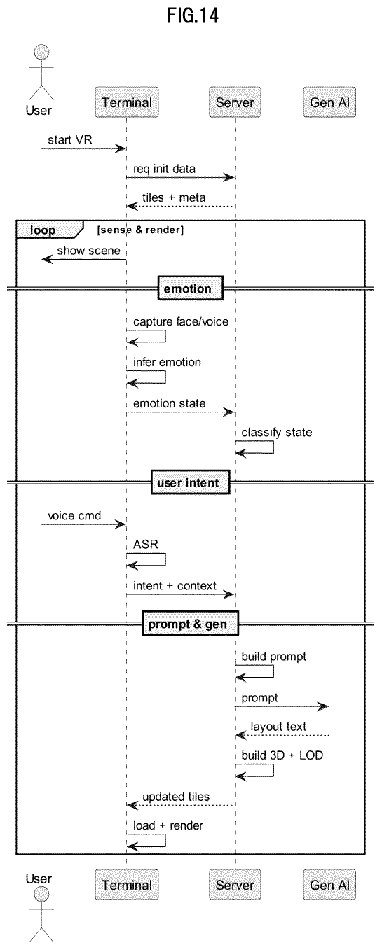

The following describes the processing flow using FIG. 14.

### Step 1:

Server receives past spatial data and current spatial data from terminal or external data sources. Server's input includes vector geographic information data, raster image data such as satellite images and aerial photographs, and tabular statistical data such as population, traffic, and climate records. Server parses file headers and metadata, identifies data types and coordinate reference systems, and writes raw files to a storage device while inserting metadata records (city identifier, time range, coordinate system, data type, file path) into a database.

Server's output is a set of stored raw data files and corresponding metadata entries in the database.

### Step 2:

Server loads the stored spatial and statistical data using a geographic information processing library. Server's input is the raw vector layers, raster images, and statistical tables referenced by metadata. Server reprojects raster images into a standard coordinate reference system, resamples them to a unified resolution, and clips them to a defined urban region. Server reprojects vector layers such as roads, buildings, and green areas into the same coordinate system and filters them by feature type. Server aggregates statistical data by year and by spatial mesh unit using a data processing library. Server's output is normalized spatial and statistical datasets, each record keyed by mesh identifier and time index with aligned coordinates and time stamps.

### Step 3:

Server extracts urban structure indicators from the normalized spatial data. Server's input is the unified raster images and vector layers from Step 2. Server executes an image segmentation neural network on the raster images, assigning each pixel a semantic class such as building, road, green area, or water. Server performs connected component analysis on each class region, converts building regions into polygons and road regions into polylines, and stores them as vector geometries. Server aggregates these geometries per mesh unit to compute building area, building count, total road length, intersection count, and green area ratio. Server's output is a feature table of urban structure indicators indexed by mesh and time.

### Step 4:

Server computes future prediction indicators using a time-series prediction model. Server's input is the urban structure indicator table from Step 3 and historical statistical time series such as population and traffic counts. Server constructs spatiotemporal tensors where each element corresponds to a mesh-time pair and contains feature channels derived from the indicators and statistics. Server feeds these tensors into a trained time-series neural network (for example, an LSTM or temporal convolutional network) and performs inference to predict future population density, traffic demand, and environmental load indicators for designated future years. Server maps predictions back to mesh units and stores them as future-layer tables. Server's output is a set of future prediction indicator layers for one or more future time points.

### Step 5:

Terminal initializes sensing and rendering components and begins capturing user-related information. Terminal's input is raw sensor signals from the imaging device, audio acquisition device, inertial sensors, and head-mounted display tracking. Terminal reads camera frames, audio buffers, and motion data in real time. Terminal uses the VR/AR run-time to prepare a blank or initial scene and configures internal buffers to receive three-dimensional assets from server. Terminal's output is a continuous stream of raw facial images, voice signals, and motion data, as well as readiness to display incoming virtual space data.

### Step 6:

Terminal estimates user emotion state based on captured facial, voice, and motion information. Terminal's input is the camera frames, audio windows, and motion vectors from Step 5. Terminal detects a face in each frame, crops and resizes the face region, and inputs it into an emotion recognition convolutional neural network to obtain probabilities for categories such as joy, boredom, confusion, and stress. Terminal extracts acoustic features such as MFCCs from audio and inputs them into a speech emotion recognition network to obtain vocal emotion probabilities. Terminal fuses facial and vocal results, optionally using a small fully connected network or weighted average, and then maps them into continuous indices: pleasure-displeasure, arousal, and engagement. Terminal smooths these indices over a time window to reduce noise. Terminal's output is an emotion state object that includes the emotion indices and timestamps.

### Step 7:

Terminal transmits emotion state information and context to server. Terminal's input is the emotion state object from Step 6 and the current simulation context, including city identifier, target year, current viewpoint, and scenario identifier. Terminal packages these values into a communication message and sends the message to server via a network protocol such as HTTP or WebSocket. Terminal's output is a sequence of emotion state messages arriving at server side, each associated with current user context.

### Step 8:

Server determines a discrete emotion label based on the received emotion state. Server's input is the emotion state messages from Step 7. Server applies threshold rules and/or a small classifier (for example, a logistic regression or shallow neural network) to the pleasure-displeasure, arousal, and engagement indices, and classifies the current user condition into labels such as “bored state,” “stressed state,” or “high-engagement state.” Server stores the determined label in session data associated with the user and current scenario. Server's output is an updated session record containing the emotion label and the latest emotion indices.

### Step 9:

Server generates an emotion-aware prompt sentence for a generative AI model. Server's input is the urban structure indicators from Step 3, the future prediction indicators from Step 4, and the emotion label from Step 8. Server selects a prompt template according to the emotion label and scenario type, then fills the template with target year, key indicator summaries (for example, congestion hotspots, high-density residential areas, climate risk zones), required number of plans, and constraints. For a bored state, server inserts phrases requesting large structural changes and high visual diversity; for a stressed state, server inserts phrases requesting minimal deviation from the current layout and enhanced explanation. Server concatenates these elements into a natural-language prompt sentence. Server's output is one or more generated prompt sentences ready to be sent to the generative AI model.

### Step 10:

Server invokes the generative AI model to produce urban layout data. Server's input is the prompt sentence or sentences from Step 9 and any structured auxiliary data such as baseline layout identifiers or numerical constraints. Server tokenizes the prompt text, maps tokens to embeddings, and sends the token sequence to a transformer-based generative AI model running in an inference environment. The model autoregressively generates output tokens that describe future urban layout elements, such as lists of blocks with coordinates, land-use types, building heights, road segments, intersections, and facility placements. Server collects the generated tokens, decodes them into text, and parses the text into structured data structures (for example, tables and graphs). Server's output is urban layout data that specifies the configuration of blocks, roads, and facilities.

### Step 11:

Server converts urban layout data into three-dimensional virtual space data. Server's input is the structured urban layout data from Step 10. Server uses a three-dimensional modeling engine to map abstract blocks and roads to specific three-dimensional template models stored in an asset library. Server computes world-space coordinates by converting layout coordinates into 3D positions, applies scaling for building heights based on layout attributes, and positions roads along specified paths. Server applies materials and textures to each object and sets lighting and environmental parameters. Server generates a full three-dimensional scene representation consisting of meshes, textures, materials, and scene graph nodes. Server's output is unoptimized virtual space data describing the entire future urban environment.

### Step 12:

Server optimizes virtual space data for delivery and real-time rendering. Server's input is the unoptimized virtual space data from Step 11. Server executes mesh simplification algorithms to reduce vertex and polygon counts while maintaining visual appearance. Server partitions the city into tiles based on spatial coordinates, generating separate mesh and texture sets per tile. For each tile, server produces multiple levels of detail by re-running simplification with different target polygon counts. Server compresses textures into GPU-friendly compressed formats and optionally applies mesh compression. Server creates metadata describing tile boundaries, levels of detail, and resource identifiers. Server's output is a collection of compressed, tile-based virtual space data bundles and associated metadata.

### Step 13:

Server delivers optimized virtual space data to terminal according to user position and context. Server's input is the tile-based virtual space data from Step 12 and the current user viewpoint and scenario information from session data. Server identifies which tiles and levels of detail are required for the current and predicted viewpoints and prepares a list of resource identifiers and transfer URLs. Server sends this list and, optionally, initiates transfer of high-priority tiles to terminal via the network interface. Server's output is a stream of 3D asset bundles and a manifest that terminal uses to load and render the scene.

### Step 14:

Terminal receives, decodes, and renders the virtual space data. Terminal's input is the compressed tile bundles and metadata from Step 13. Terminal decompresses mesh and texture data using decoding libraries and loads them into the VR/AR run-time's scene graph.

Terminal uses metadata to place tiles in the correct positions and selects levels of detail based on distance from the user's current viewpoint. Terminal updates the virtual camera transform based on head tracking data and renders the three-dimensional scene to the display at the configured frame rate. Terminal overlays user interface elements such as minimaps, time sliders, and annotation panels. Terminal's output is the visual and interactive presentation of the future urban virtual environment to user.

### Step 15:

Terminal adjusts presentation parameters in response to emotion state. Terminal's input is the latest emotion state or emotion label received indirectly via server commands or directly via periodic updates. Terminal alters heads-up display density, number of visible annotations, and camera movement speed according to the emotion state. For a stressed state, terminal reduces information overlays, slows navigation speed, and simplifies visual effects; for a high-engagement state, terminal enables additional detail overlays, shows explanatory panels when user gazes at particular regions, and highlights alternative plans. Terminal's output is an adapted visual presentation that matches user's cognitive and emotional condition and reduces unnecessary rendering load.

### Step 16:

User interacts with the virtual environment and issues high-level requests. User's input consists of controller movements, hand gestures, gaze focus on specific areas, and spoken commands such as “Show me a plan with less congestion” or “Increase green spaces near this river.” User moves within the virtual city, selects regions of interest, and verbally expresses preferences or constraints. User's output, from the system's perspective, is a combination of interaction events and audio signals that encode new requirements for the next iteration of urban layout generation.

### Step 17:

Terminal converts user speech and interaction events into structured intent information.

Terminal's input is the raw audio signal of user commands and the interaction events from controllers and gaze tracking. Terminal uses a speech recognition engine to transcribe speech into text and links the recognized phrases with the current viewpoint or selected region.

Terminal bundles the text commands and associated spatial context into a request message.

Terminal's output is an intent message containing user constraints and preferences, which is transmitted to server.

### Step 18:

Server interprets user intent and regenerates a refined prompt sentence. Server's input is the intent message from Step 17, the existing urban layout data from Step 10 or Step 11, the future prediction indicators from Step 4, and the latest emotion label from Step 8. Server applies natural language processing to the transcribed text to extract explicit constraints (for example, “reduce congestion by at least 50%,” “add more parks near residential areas,” “increase facilities for families with children”) and maps these to quantitative targets using predefined rules or models. Server combines these targets with emotion-aware conditions (for example, maintain clarity if user is stressed) and inserts them into a new prompt template.

Server produces a refined prompt sentence such as:

“You are a generative AI model for urban plan refinement for the year 2050. The user strongly requests further congestion reduction and a family-friendly environment. Using the existing layout as a baseline and the predicted traffic and population layers, generate two alternative layouts that reduce peak congestion by at least 50% and place childcare centers, schools, and parks within a 10-minute walk from residential blocks. Provide structured output listing each modification and its coordinates.”

Server's output is the refined prompt sentence and updated constraint set, which are passed again to the generative AI model for a new generation cycle.

The data generation model 58 is a so-called generative artificial intelligence (AI). Examples of the data generation model 58 include generative AIs such as ChatGPT (registered trademark) (Internet search <URL: https:/openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

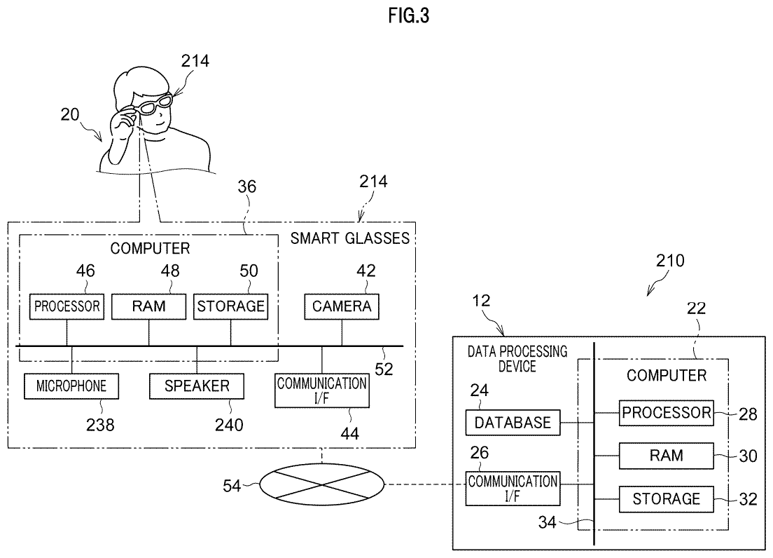

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

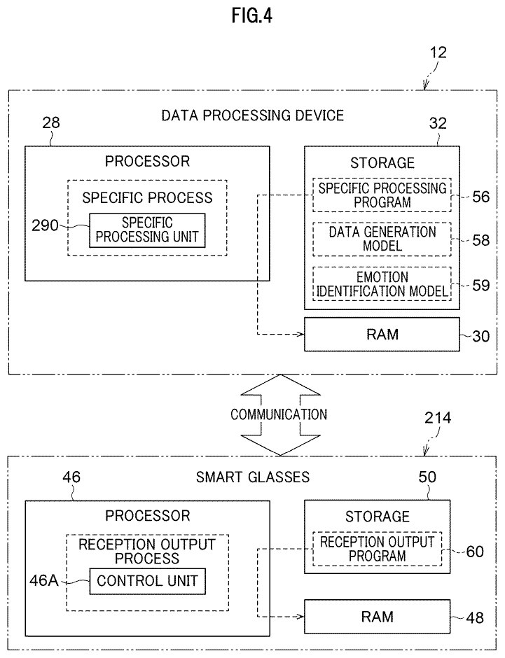

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

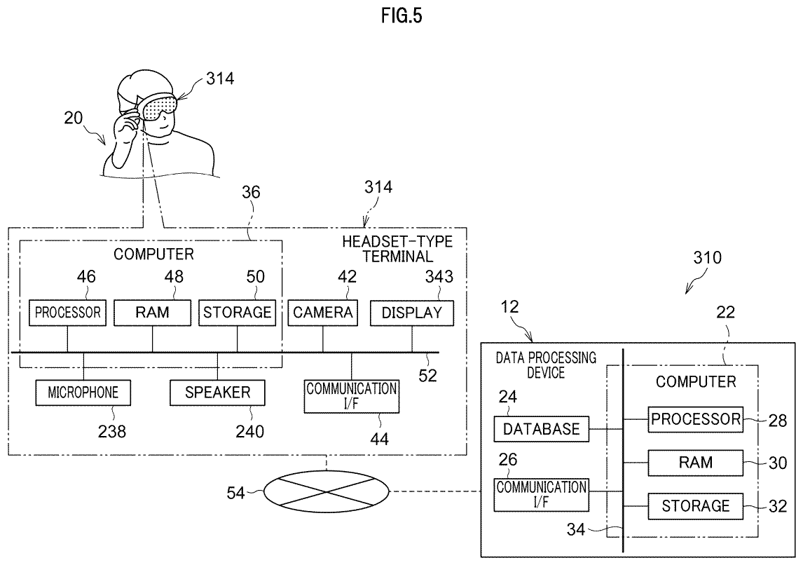

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

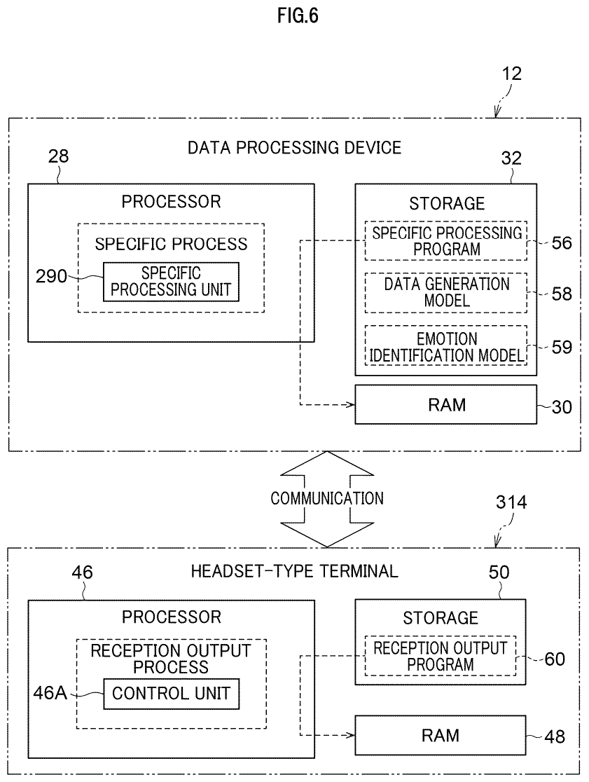

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56.

The specific processing is implemented by the processor 28 operating as the specific processing unit 290 according to the specific processing program 56 executed in the RAM 30. The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12.

For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

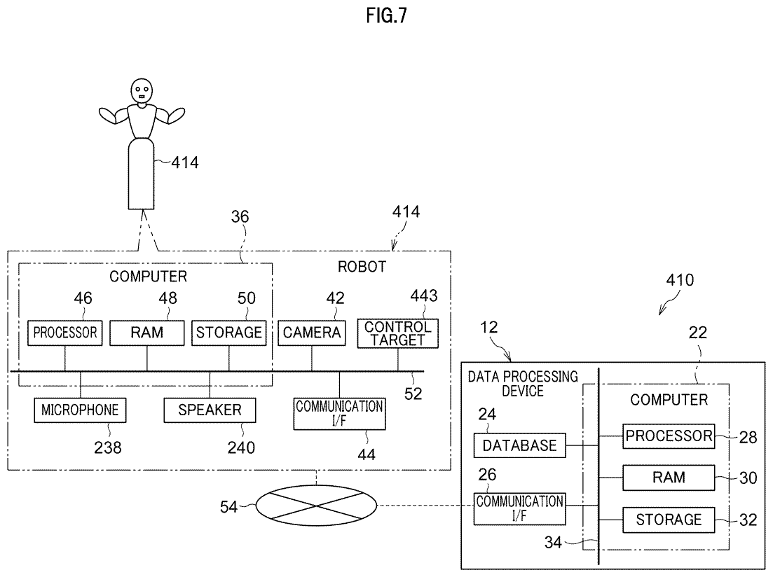

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34.

The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

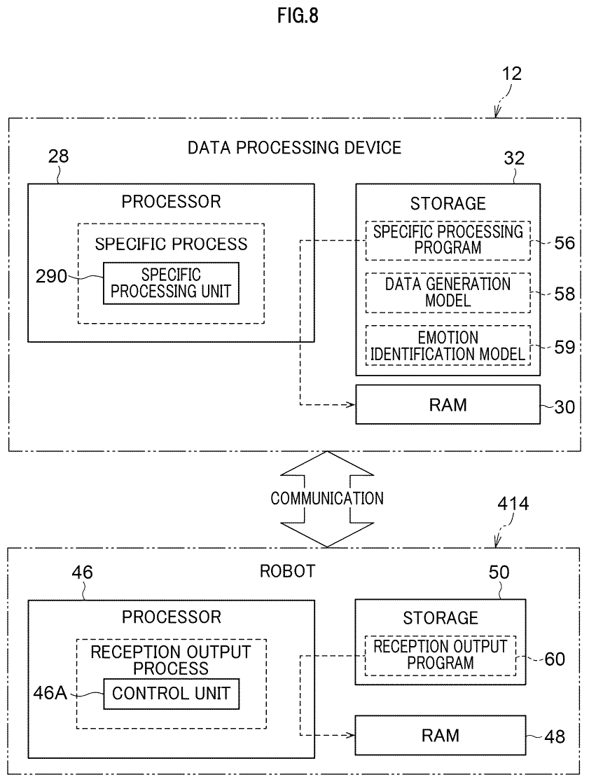

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

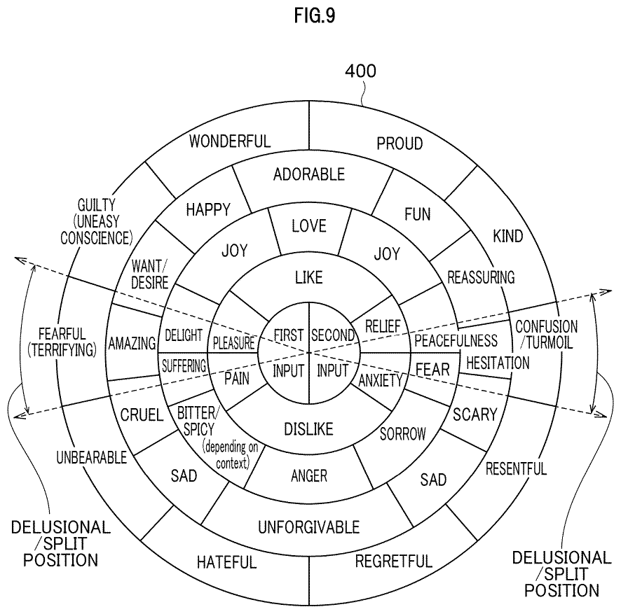

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

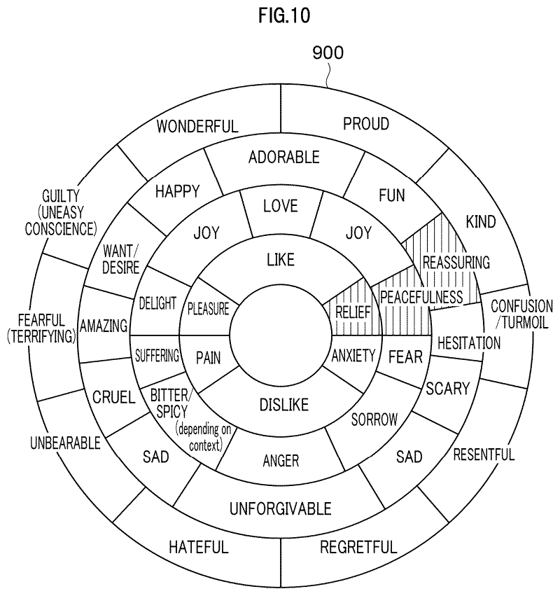

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof, This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure.

Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to function as an information input unit configured to acquire information including past image information and position information, and
wherein the processor is configured to function as an analysis unit configured to analyze the information acquired by the information input unit, to extract feature information including shape information, appearance information, and arrangement information of an object, and to construct generation text information as a prompt sentence on the basis of the feature information and user designation information, and
wherein the processor is configured to function as a virtual space generation unit configured to provide the generation text information constructed by the analysis unit as input information to a generative artificial intelligence model, to obtain image information or three-dimensional shape information output from the generative artificial intelligence model, and to generate three-dimensional space information on the basis of the feature information and the image information or the three-dimensional shape information, and
wherein the processor is configured to function as an optimization unit configured to perform a reduction process including shape simplification processing and image compression processing and to perform generation of multi-level detail information with respect to the three-dimensional space information generated by the virtual space generation unit, to convert the three-dimensional space information into a distribution format in which the three-dimensional space information is sequentially transmittable to a user terminal device, and to enable output of display three-dimensional space information on the basis of operation information and position information used for display control of the three-dimensional space information in the user terminal device, and
wherein the processor is configured to function as a user interface unit configured to acquire operation information and audio information of a user in the user terminal device, to generate viewpoint information and movement information in response to the operation information, and to convert the audio information into text information and transmit the text information to the analysis unit.

### (Supplementary 2)

The system according to supplementary 1,
wherein the processor is configured to function as the information input unit that is further configured to receive a plurality of types of electronic information including still image information and map information acquired by using a portable information terminal device or an information processing device having an imaging function, geographic coordinate information acquired by using a position information acquisition device having a positioning function, and past geographic information acquired from an online information providing device,
wherein the processor is configured to function as the analysis unit that is further configured to analyze building outline information, color information, surface pattern information, urban arrangement information, and terrain information by using image analysis processing and geographic information processing, to store the extracted feature information in association with the position information, and to construct the generation text information as the prompt sentence on the basis of era information and region information received as the user designation information,
wherein the processor is configured to function as the virtual space generation unit that is further configured to generate three-dimensional shape information constituting terrain information, road information, and building information in the three-dimensional space information, and to apply appearance information of building surfaces and environmental elements by using the image information obtained from the generative artificial intelligence model, and
wherein the processor is configured to function as the optimization unit that is further configured to divide the three-dimensional space information by region, to set the multi-level detail information for each region, and thereby to enable sequential distribution of only a necessary region in response to a request from the user terminal device.

### (Supplementary 3)

The system according to supplementary 1,
wherein the processor is configured to function as the analysis unit that is further configured, in a case of generating an imaginary environment, to extract high-level concept information from concept diagram information, rough sketch information, and text description information provided by the user, to generate configuration rule information including floating structure information, three-dimensional connection path information, and vegetation arrangement information on the basis of the high-level concept information, and to construct the generation text information as the prompt sentence reflecting the configuration rule information as the input information to the generative artificial intelligence model,
wherein the processor is configured to function as the virtual space generation unit that is further configured to arrange virtual structure information including the floating structure information and the three-dimensional connection path information in the three-dimensional space information on the basis of the configuration rule information and the image information or the three-dimensional shape information output from the generative artificial intelligence model, and
wherein the processor is configured to function as the optimization unit that is further configured to adjust the three-dimensional space information so that a display quality corresponds to processing performance of the user terminal device, and to function as the user interface unit that is further configured to receive viewpoint change operations, position movement operations, and sharing operations with respect to the three-dimensional space information and, in cooperation with the virtual space generation unit and the optimization unit, to generate three-dimensional space information for another user.

### Application Example 1

### (Supplementary 1)

A system comprising a processor,
wherein the processor is configured to
receive past information data and current location information via an input unit, integrate the received information data and normalize the integrated information data on a time axis and a spatial axis to extract growth tendencies, movement tendencies, population tendencies, and environmental tendencies via an analysis unit,
construct a prompt sentence including text information describing the extracted tendencies and design conditions based on the extracted tendencies and target conditions provided from a user, input the prompt sentence into a generative AI model, and obtain configuration information of a future environment via a configuration information acquisition unit,
automatically generate a three-dimensional virtual space model including building elements, route elements, public space elements, vegetation elements, and supply facility elements based on the obtained configuration information of the future environment via a generation unit,
divide the generated three-dimensional virtual space model into a plurality of spatial regions and a plurality of levels of detail, perform size reduction processing and encoding processing on shape information and display information of the three-dimensional virtual space model, and configure the processed information as presentation data via an optimization unit,
provide the presentation data to a user terminal on a region basis and a level-of-detail basis, and enable a user to experience the future environment through display processing, movement processing, selection processing, voice input processing, and motion input processing executed on the user terminal via an experience control unit,
update the design conditions or evaluation conditions based on voice instructions and motion instructions from the user, reconstruct an updated prompt sentence reflecting the updated conditions, input the updated prompt sentence into the generative AI model, and regenerate at least a part of or all of the three-dimensional virtual space model based on newly obtained configuration information via a regeneration control unit,
and share the three-dimensional virtual space model and associated condition information with another user terminal and manage position information and annotation information of a plurality of users to enable a collaborative experience via a collaboration control unit.

### (Supplementary 2)

The system according to supplementary 1,
wherein the processor is configured to
receive, as the past information data and the current location information, a plurality of types of electronic data including image data, location reference data, movement amount data, population statistical data, and environmental observation data via the input unit, calculate, by the analysis unit, building regions, route structures, land-use structures, terrain structures, and usage density distributions by image analysis processing and geographic information processing,
supply, by the configuration information acquisition unit, the generative AI model with the prompt sentence including a future time point, an accommodation number, a movement means configuration, a green area ratio, a supply network configuration, and environmental constraints to obtain machine-readable structured data representing route elements, building elements, space elements, and supply elements,
map, by the generation unit, each element in the machine-readable structured data to three-dimensional shapes and associated information,
perform, by the optimization unit, element number reduction processing, hierarchical level-of-detail generation processing, and compression processing on the three-dimensional shapes and the associated information,
and selectively transmit, by the experience control unit, presentation data corresponding to a necessary region based on a position of the user to the user terminal so as to reduce display load and communication load.

### (Supplementary 3)

The system according to supplementary 1,
wherein the processor is configured to
specify, by the regeneration control unit, only configuration information corresponding to an area or an element group designated by the voice instructions and the motion instructions from the user,
include identification information of the designated area or the designated element group and a modification policy in the prompt sentence for re-input to the generative AI model, obtain a partial future environment plan from the generative AI model,
execute, for only a corresponding region of the three-dimensional virtual space model, re-generation processing of three-dimensional shapes and optimization processing based on the partial future environment plan,
and sequentially deliver updated presentation data to the user terminal so that the user terminal performs interactive update display of the future environment in response to operations of the user.

### Example 2

### (Supplementary 1)

A system comprising a processor,
wherein the processor is configured to receive, from an input device, input information including past image information and geographic information and to transmit the input information to an information processing apparatus,
execute image processing and geographic information processing on the past image information and the geographic information to extract building shape information representing three-dimensional shapes of structures and urban layout information representing spatial arrangement relationships of components in an urban space,
acquire, from a terminal device, emotion-related information including facial image information, audio information, and operation history information of a user and store the emotion-related information,
analyze the facial image information, the audio information, and the operation history information using an emotion analysis model to calculate emotion indices of the user and estimate a multi-dimensional emotion state of the user,
generate a prompt sentence for input to a generative artificial intelligence model based on the building shape information, the urban layout information, the estimated emotion state, and usage information indicating a usage purpose,
input the prompt sentence as text to the generative artificial intelligence model and generate three-dimensional virtual city space data including at least structures, roads, terrain, and characters based on an inference process of the generative artificial intelligence model, optimize the three-dimensional virtual city space data by performing at least polygon count reduction, texture compression, and multi-level resolution setting to generate lightweight data according to a display load of the terminal device, and
transmit the lightweight three-dimensional virtual city space data to the terminal device and cause the terminal device to perform display control and viewpoint control of a three-dimensional virtual city space using a display device and a position and posture detection device.

### (Supplementary 2)

The system according to supplementary 1,
wherein the processor is configured to analyze the facial image information by using a machine learning model for facial expression recognition to calculate probability distributions of expression categories and to generate expression-based emotion scores,
analyze the audio information by extracting acoustic feature quantities and by applying an audio emotion recognition model to generate numerical indices of arousal and valence, analyze the operation history information by extracting behavioral feature quantities including at least operation frequency, viewpoint change frequency, and stay time and by applying a behavioral analysis model to generate indices of interest and boredom,
integrate a plurality of indices derived from the facial image information, the audio information, and the operation history information by using an integration model to generate an emotion state vector including at least pleasantness, arousal, interest, anxiety, and boredom, and
dynamically insert, into the prompt sentence, descriptions relating to at least time of day, atmosphere, crowd density, presence or absence of explanatory information, and presence or absence of event scenes based on the emotion state vector and the usage information.

### (Supplementary 3)

The system according to supplementary 1,
wherein the processor is configured to
generate the three-dimensional virtual city space data by using at least one of a generative artificial intelligence model that generates two-dimensional images from text and a generative artificial intelligence model that generates three-dimensional shapes from text,
construct the three-dimensional virtual city space data by performing at least one of a three-dimensional reconstruction process from a plurality of viewpoint images and a process of generating individual object meshes and placing the individual object meshes based on the urban layout information, and
cause the three-dimensional virtual city space to change in real time in response to the emotion state of the user by repeatedly executing, during an experience of the three-dimensional virtual city space, the emotion analysis and the prompt sentence generation based on emotion-related information that is continuously acquired, generating additional prompt sentences for event scenes or changes in illumination conditions, and transmitting, to the terminal device, differential update data generated based on the additional prompt sentences.

### Application Example 2

### (Supplementary 1)

A system comprising a processor,
wherein the processor is configured to
acquire past spatial data and current spatial data from a communication line or a storage device, normalize the spatial data based on coordinate reference information and time information, and store the normalized spatial data together with metadata in a storage structure,
analyze the stored spatial data and statistical data by executing image processing, time-series processing, and spatial processing to calculate feature values including urban structure indicators and future prediction indicators,
generate a prompt sentence that describes a generation target and generation conditions for a generative AI model on the basis of the calculated feature values and future time conditions, input the prompt sentence into the generative AI model, and thereby generate urban layout data representing an urban structure,
convert the urban layout data into virtual space data by performing three-dimensional modeling processing, and perform load-reduction processing including polygon simplification, data partitioning, and level-of-detail setting on the virtual space data so as to optimize the virtual space data for a terminal device,
obtain at least one of facial information, voice information, and motion information of a user from the terminal device, execute emotion estimation processing on the obtained information, and calculate an emotion state including at least a pleasure-displeasure index, an arousal index, and an engagement index,
dynamically change at least one of a content of the prompt sentence to be input to the generative AI model and a presentation mode of the virtual space data in accordance with the calculated emotion state, and control operations of the generation of the urban layout data and the optimization of the virtual space data based on the changed content or presentation mode, and
cause a user interface to perform three-dimensional display based on the optimized virtual space data and to accept user operations including viewpoint movement, selection operation, and voice input, and output corresponding interaction responses to the terminal device.

### (Supplementary 2)

The system according to supplementary 1,
wherein the processor is configured to
receive a plurality of types of digital data including geographic information data, image data, and statistical data, perform coordinate reference unification and region clipping on the geographic information data by using a geographic information processing program, classify building regions, traffic route regions, and green regions from the image data by using an image analysis program and a machine learning program, calculate, for each spatial mesh unit, statistical values including building density, traffic route length, intersection density, and green ratio, and further use a time-series prediction model to predict future values of population distribution, traffic demand, and environmental load indicators.

### (Supplementary 3)

The system according to supplementary 1,
wherein the processor is configured to
execute face detection processing on a face image acquired by the terminal device and perform inference processing by using an emotion recognition machine learning model,
extract acoustic features from a voice signal and perform inference processing by using a speech emotion recognition model, integrate inference results from the face image and the voice signal to generate the emotion state including the pleasure-displeasure index, the arousal index, and the engagement index, add, to the prompt sentence, a condition that requests an urban plan having a large amount of visual change or a condition that requests an urban plan similar to a current structure with explanatory information added, in accordance with the emotion state, and adjust presentation parameters including an amount of displayed information, a number of displayed objects, and a movement speed in the virtual space data.

What is claimed is:

1. A system comprising:
circuitry configured to:
receive, via a communication interface coupled to a packet-switched network, image data and geographic information data from at least one of a terminal device and a storage device coupled to the packet-switched network;
analyze the image data and the geographic information data to extract feature data representing attributes of structures and terrain;
construct a prompt data structure based on the feature data and user designation data, transmit the prompt data structure to a generative neural network model, and receive generated output data from the generative neural network model;
generate three-dimensional space data based on the feature data and the generated output data;
perform optimization processing on the three-dimensional space data including at least shape simplification and image compression to produce optimized three-dimensional space data; and
transmit the optimized three-dimensional space data to the terminal device via the communication interface.

2. The system according to claim 1, wherein the circuitry analyzes the image data by extracting spatial feature vectors from the image data using a convolutional neural network comprising a plurality of convolutional layers, normalization layers, and pooling layers, and classifies architectural style categories and terrain type categories based on the spatial feature vectors.

3. The system according to claim 2, wherein the circuitry further analyzes the image data by extracting shape information representing contours, boundaries, and height estimates of structures, appearance information representing color distributions, textures, and material attributes of surfaces, and arrangement information representing spatial relationships and relative placement of structures and terrain within a scene.

4. The system according to claim 3, wherein the circuitry processes the geographic information data to associate the shape information, the appearance information, and the arrangement information with geographic coordinate data, and generates a georeferenced feature map in which extracted features are mapped to positions in a coordinate system derived from the geographic information data.

5. The system according to claim 4, wherein the image data includes at least one of historical photographs, map images, and aerial photograph images, and wherein the circuitry performs temporal alignment processing to reconcile features extracted from image data captured at different time periods into a consistent georeferenced feature map.

6. The system according to claim 1, wherein the prompt data structure includes a content specification derived from the feature data and a style specification derived from the user designation data, and wherein the generative neural network model comprises a diffusion-based model that generates the generated output data as at least one of texture image data and three-dimensional shape data in response to the prompt data structure.

7. The system according to claim 6, wherein the circuitry generates the three-dimensional space data by constructing polygon mesh geometry based on shape information included in the feature data, mapping the texture image data received from the generative neural network model onto surfaces of the polygon mesh geometry, and positioning the polygon mesh geometry according to arrangement information included in the feature data.

8. The system according to claim 7, wherein the circuitry further generates the three-dimensional space data by constructing terrain geometry based on elevation data derived from the geographic information data, applying terrain texture data to the terrain geometry, and integrating the polygon mesh geometry of structures with the terrain geometry to produce a spatially coherent three-dimensional environment.

9. The system according to claim 8, wherein the user designation data includes at least one of a target era identifier, a target region identifier, a desired architectural style, and conceptual sketch data, and wherein the circuitry encodes the user designation data into the prompt data structure to cause the generative neural network model to generate texture image data and three-dimensional shape data that reflect creative elements not present in the image data.

10. The system according to claim 1, wherein the optimization processing further includes generating multi-level detail representations of the three-dimensional space data, each level having a different polygon count and texture resolution, and selecting a level for transmission to the terminal device based on processing capability information received from the terminal device.

11. The system according to claim 10, wherein the circuitry segments the three-dimensional space data into a plurality of spatial regions, assigns each spatial region a priority based on a current viewpoint of the user, and transmits spatial regions in order of priority such that regions proximate to the current viewpoint are transmitted at a higher level of detail than regions distant from the current viewpoint.

12. The system according to claim 11, wherein the circuitry constructs a navigation mesh from the optimized three-dimensional space data defining traversable surfaces and obstacle boundaries, and transmits the navigation mesh together with the spatial regions to the terminal device for controlling movement of a viewpoint within the three-dimensional space.

13. The system according to claim 1, wherein the circuitry is further configured to receive, via the communication interface, user operation data from the terminal device including at least one of viewpoint change data and audio data representing a voice query, and to update the prompt data structure based on the user operation data and retransmit the updated prompt data structure to the generative neural network model to obtain updated generated output data for modifying a portion of the three-dimensional space data.

14. The system according to claim 13, wherein the circuitry converts the audio data to text data using a speech recognition model, extracts a query intent from the text data, and constructs the updated prompt data structure by encoding the query intent together with current viewpoint information and the feature data corresponding to a region visible from the current viewpoint.

15. The system according to claim 1, wherein the circuitry is further configured to:
receive, via the communication interface, at least one of facial image data, acoustic data, and interaction log data from the terminal device; and
estimate an emotional state of the user based on the received data using an emotion estimation model.

16. The system according to claim 15, wherein the circuitry adjusts the prompt data structure based on the estimated emotional state to modify at least one of an atmosphere parameter, an event density parameter, and a complexity parameter in the prompt data structure before transmitting the prompt data structure to the generative neural network model.

17. The system according to claim 16, wherein the circuitry further adjusts the optimization processing based on the estimated emotional state by modifying at least one of a polygon budget, a texture resolution, and a streaming priority to reduce computational load on the terminal device when the estimated emotional state indicates a stress condition.

18. A system comprising:
a communication interface including a network interface controller coupled to a packet-switched network and configured to transmit and receive data packets;
a memory storing instructions, a convolutional neural network model, a generative neural network model, and optimization parameters; and
circuitry comprising one or more processors coupled to the memory and configured to execute the instructions to:
receive, via the communication interface, image data and geographic information data from at least one of a terminal device and a storage device coupled to the packet-switched network;
extract spatial feature vectors from the image data using the convolutional neural network model and process the geographic information data to generate a georeferenced feature map associating the spatial feature vectors with geographic coordinates;
construct a prompt data structure including a content specification derived from the georeferenced feature map and a style specification derived from user designation data, and transmit the prompt data structure to the generative neural network model to obtain at least one of texture image data and three-dimensional shape data;
generate three-dimensional space data by constructing polygon mesh geometry based on the georeferenced feature map and mapping the texture image data onto surfaces of the polygon mesh geometry;
perform optimization processing on the three-dimensional space data including shape simplification, image compression, multi-level detail generation, and region-based segmentation to produce optimized three-dimensional space data adapted to a processing capability of the terminal device; and
transmit the optimized three-dimensional space data to the terminal device via the communication interface.

19. The system according to claim 18, wherein the circuitry is further configured to receive user operation data from the terminal device via the communication interface, update the prompt data structure based on the user operation data, retransmit the updated prompt data structure to the generative neural network model to obtain updated texture image data or three-dimensional shape data, and modify a portion of the three-dimensional space data based on the updated texture image data or three-dimensional shape data.

20. A method performed by circuitry of a server coupled to a packet-switched network via a communication interface, the method comprising:
receiving, via the communication interface, image data and geographic information data from at least one of a terminal device and a storage device coupled to the packet-switched network;
analyzing the image data and the geographic information data to extract feature data representing attributes of structures and terrain;
constructing a prompt data structure based on the feature data and user designation data, transmitting the prompt data structure to a generative neural network model, and receiving generated output data from the generative neural network model;
generating three-dimensional space data based on the feature data and the generated output data;
performing optimization processing on the three-dimensional space data including at least shape simplification and image compression to produce optimized three-dimensional space data; and
transmitting the optimized three-dimensional space data to the terminal device via the communication interface.
